(19) United States
(12) Patent Application Publication
(10) Pub. No.: US 2019/0103789 A1
(43) Pub. Date: Apr. 4, 2019

(54) METHOD FOR PRODUCING STATOR FOR MOTORS, AND STATOR FOR MOTORS

(71) Applicant: Seiko Instruments Inc., Chiba-shi (JP)

(72) Inventors: Kosuke YAMAMOTO, Chiba-shi (JP); Shinji KINOSHITA, Chiba-shi (JP)

(21) Appl. No.: 16/144,063

(22) Filed: Sep. 27, 2018

(30) Foreign Application Priority Data
Sep. 29, 2017 (JP) 2017-190671
Sep. 13, 2018 (JP) 2018-171888

(51) Int. Cl. H02K 15/02; G04C 3/14

(52) U.S. Cl. CPC H02K 15/02; H02K 1/02; G04C 3/146

(57) ABSTRACT

Provided herein is a method for producing a stator for motors, and a stator for motors with which heat deformation due to laser irradiation at the time of forming a non-magnetic region can be reduced. A method for producing a stator for motors includes an unmagnetizing step of forming a non-magnetic region in a magnetic sheet material, and a working step of working a part of the non-magnetic region in the magnetic sheet material so as to form a hole for a rotor of a motor.

### RELATED APPLICATIONS

This application claims priority under 35 U.S.C. § 119 to Japanese Patent Application Nos. 2017-190671 filed on Sep. 29, 2017 and 2018-171888 filed on Sep. 13, 2018, the entire content of which are hereby incorporated by reference.

### BACKGROUND OF THE INVENTION

### 1. Field of the Invention

The present invention relates to a method for producing a stator for motors, and to a stator for motors.

### 2. Description of the Related Art

An analog electronic timepiece that uses a motor drive unit to drive rotation of hands (e.g., an hour hand, and a minute hand) is in use. A stepping motor is used as the motor of such a motor drive unit.

A stepping motor includes a stator having a rotor housing, and a locator (inner notch) for locating a stop position of a rotor; a rotor that is rotatably disposed inside the rotor housing, and coils provided for the stator.

For the rotation of a stepping motor, a drive circuit alternately sends a drive pulse of different polarity to the coils. In response to these drive pulses, a leakage magnetic flux of different polarity alternately occurs in the stator. In the stepping motor, the rotor rotates 180 degrees in a predetermined direction (forward direction) every time the drive pulse is applied, and the rotor stops at a position corresponding to the locator.

A stepping motor typically uses an integrated stator in which the circumference of the rotor housing provided for the rotor has two narrow portions (180-degree positions) to help saturate the magnetic flux. The leakage magnetic flux that drives the rotor more easily occurs with this structure.

It has been proposed to form a Cr diffused region (a melted and solidified region of non-magnetic material chromium) in a part of the magnetic path provided around a rotor housing (a through-hole for a rotor) so that the stepping motor can have reduced magnetic permeability in this region (see, for example, JP-A-2016-136830). In the invention described in this related art, an Fe-Ni alloy sheet is machined such as by punching to form a stator material having a rotor housing (a through hole for a rotor), and a magnetic path R formed around the rotor housing. Here, narrow portions are also formed. In this related art, a Cr material to be melted and diffused is placed on at least a part of the stator material, and a laser is applied to the Cr material to melt and diffuse the Cr material inside the magnetic path R, and form a Cr diffused region (non-magnetic region) in, for example, the narrow portions. The narrow portions have a width of, for example, 0.1 mm each. In order to melt chromium, the laser has a temperature equal to or greater than the melting point of chromium, for example, 1,900 degrees.

In the foregoing related art, the Cr diffused region is formed in the narrow portions by laser irradiation after punching, and there is a possibility of the narrow portions deforming under the heat of the laser.

### SUMMARY OF THE INVENTION

It is an aspect of the present application to provide a method for producing a stator for motors, and a stator for motors with which heat deformation due to laser irradiation at the time of forming a non-magnetic region can be reduced.

According to the aspect of the present application, there is provided a method for producing a stator for motors, the method including an unmagnetizing step (second production step) of forming a non-magnetic region in a magnetic sheet material, and a working step (third production step) of working a part of the non-magnetic region in the magnetic sheet material so as to form a hole for a rotor of a motor.

The method for producing a stator for motors according to the aspect of the application may be such that the unmagnetizing step includes a chromium applying step (second production step) of applying chromium to the magnetic sheet material, and a laser irradiation step (second production step) of applying a laser beam to the magnetic sheet material in thickness direction.

The method for producing a stator for motors according to the aspect of the application may be such that the unmagnetizing step includes a chromium applying step (second production step) of continuously applying chromium to the magnetic sheet material, and a laser irradiation step (second production step) of applying a laser beam to the magnetic sheet material in thickness direction.

The method for producing a stator for motors according to the aspect of the application may include a guide-hole forming step (first production step) of forming a guide hole through the magnetic sheet material before the unmagnetizing step, wherein the chromium applying step uses the guide hole as a reference to apply chromium, the laser irradiation step uses the guide hole as a reference to apply a laser beam, and the working step uses the guide hole as a reference to work a part of the non-magnetic region.

The method for producing a stator for motors according to the aspect of the application may be such that the magnetic sheet material is a sheet material of an Fe—Ni—Cr alloy containing 37.5% to 38.5% nickel, 7.5 to 8.5% chromium, and 52.5% to 54.5% iron, and that the non-magnetic region includes a region with a chromium content of 15% or more.

The method for producing a stator for motors according to the aspect of the application may be such that the working step is a step of punching a part of the non-magnetic region, a step of cutting a part of the non-magnetic region with a laser, or a step of working a part of the non-magnetic region by wire discharge.

According to another aspect of the application, there is provided a stator (stator 201) for motors, the stator including a non-magnetic molten region (molten portion 401, narrow portions 210 and 211) formed around a rotor hole (rotor housing 203) of a magnetic sheet material by melting and unmagnetizing the magnetic sheet material, the non-magnetic molten region having a cross section that becomes smaller from a first surface of the magnetic sheet material toward a second surface of the magnetic sheet material in thickness direction.

The stator for motors according to the aspect of the application may be such that the rotor hole has a roundness of 99.5% or more.

The stator for motors according to the aspect of the application may be such that the magnetic sheet material is a sheet material of an Fe—Ni—Cr alloy containing 37.5% to 38.5% nickel, 7.5 to 8.5% chromium, and 52.5% to 54.5% iron, and that the non-magnetic molten region includes a region with a chromium content of 15% or more.

The stator for motors according to the aspect of the application may be such that the chromium in the non-magnetic molten region is 6% to 18% higher by weight than in a region of the magnetic sheet material other than the non-magnetic molten region.

The stator for motors according to the aspect of the application may be such that the non-magnetic molten region is a region of the magnetic sheet material where the distance from the rotor hole to an outer edge of the magnetic sheet material is narrower than in other parts of the magnetic sheet material.

The present application has enabled reducing the heat deformation due to laser irradiation at the time of forming a non-magnetic region.

### BRIEF DESCRIPTION OF THE DRAWINGS

FIG. 1 is a block diagram showing a timepiece using a stepping motor and a timepiece movement according to an embodiment of the invention.

FIG. 2 is a perspective view showing an exemplary schematic structure of the stepping motor according to the embodiment.

FIG. 3 is a front schematic view of a stator according to the embodiment.

FIG. 4 shows a front schematic view of the stepping motor according to the embodiment.

FIG. 5 is a diagram representing an example of a method for producing a stator according to the embodiment.

FIG. 6 is a top view of a hoop material before pressing of the stator according to the embodiment.

FIG. 7 is a diagram showing an example of a picture of a cross section of a permalloy hoop material after the chromium applied to the hoop material is melted and diffused with a laser to provide a chromium concentration of 15 weight % or more according to the embodiment.

FIG. 8 is a diagram showing an example of a picture of a cross section of a permalloy hoop material after the chromium applied to the hoop material is melted and diffused with a laser to provide a chromium concentration of 15 weight % or more according to the embodiment.

FIG. 9 is a diagram showing an example of a picture of a cross section of a permalloy hoop material after the chromium applied to the hoop material is melted and diffused with a laser to provide a chromium concentration of 15 weight % or more according to the embodiment.

FIG. 10 is a diagram representing an example of the result of an EDS line analysis of the molten portion according to the embodiment.

FIG. 11 is a ternary alloy phase diagram of Fe—Ni—Cr.

FIG. 12 is a diagram representing examples of current waveforms of an integrated stator and a separate stator, and examples of drive pulses for reverse rotation.

FIGS. 13A and 13B are diagrams describing the technique used to produce a stator of Comparative Example. FIG. 13C is a diagram showing a hoop material cut at the time of plating in Comparative Example.

FIG. 14 is a graph representing changes in the current value of a coil against time in three types of stators.

FIG. 15A is a diagram showing a rotor housing in the absence of deformation. FIG. 15B is a diagram showing a rotor housing in the presence of deformation. FIG. 15C is a diagram describing the horizontal axis of the stator, and the static angle θ of the rotor.

FIG. 16 is a diagram representing changes in torque with rotor angle in the presence and absence of deformation in the rotor housing.

FIG. 17A is a diagram representing changes in cogging torque with rotor angle in the absence of deformation in the rotor housing. FIG. 17B is a diagram representing changes in stored energy with rotor angle in the absence of deformation in the rotor housing. FIG. 17C is a diagram representing changes in integral torque with rotor angle in the absence of deformation in the rotor housing.

FIG. 18A is a diagram representing changes in cogging torque with rotor angle in the presence of deformation in the rotor housing. FIG. 18B is a diagram representing changes in stored energy with rotor angle in the presence of deformation in the rotor housing. FIG. 18C is a diagram representing changes in integral torque with rotor angle in the presence of deformation in the rotor housing.

FIG. 19 is a diagram representing a variation of the embodiment with respect to chromium application.

FIG. 20A shows a perspective view of a hoop material after the formation of a chromium layer according to a variation. FIG. 20B shows a cross sectional view after the formation of a chromium layer, taken at Y-Y′ of the hoop material illustrated in FIG. 20A.

FIG. 21 is an elevational view of a hoop material before punching stators for two-coil motors according to a variation.

FIG. 22 shows an elevational view before pressing of stators for two-coil motors according to a variation.

FIG. 23 is a diagram representing an example in which the third production step in the stator producing method according to the embodiment is performed by laser cutting.

FIG. 24 is a diagram representing an example in which the third production step in the stator producing method according to the embodiment is performed by wire discharge.

### DETAILED DESCRIPTION OF THE PREFERRED EMBODIMENTS

An embodiment of the present invention is described below with reference to the accompanying drawings. In the drawings referred to in the following descriptions, the scale is appropriately varied to show members in sizes that are easily recognizable.

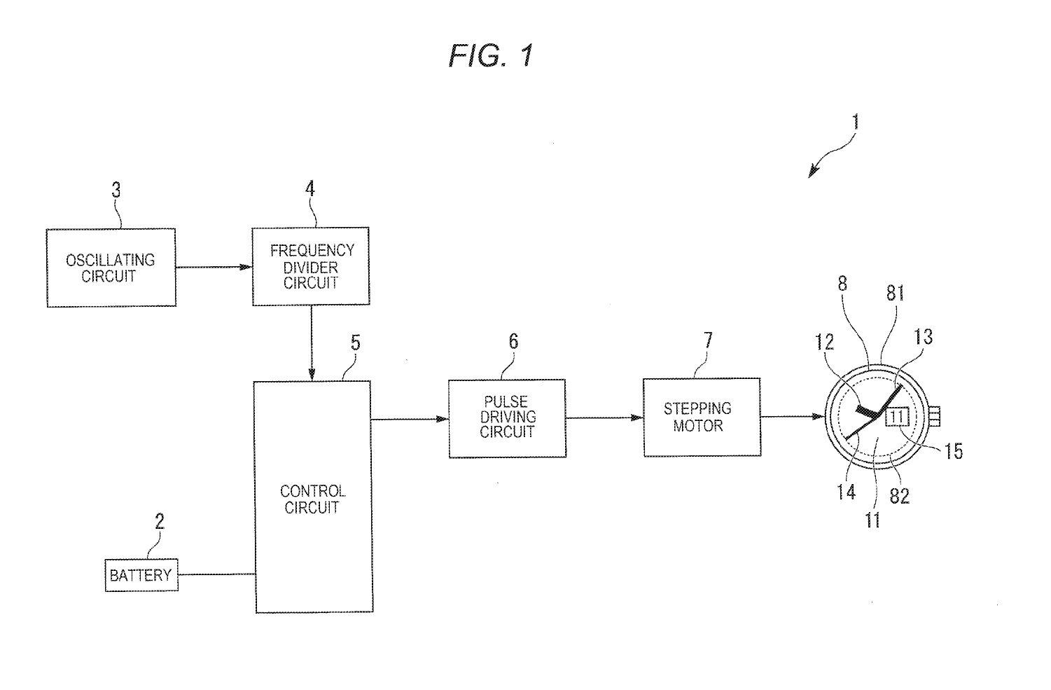

FIG. 1 is a block diagram showing a timepiece 1 using a stepping motor and a timepiece movement according to an embodiment of the invention. In the present embodiment, the timepiece is described by taking an analog electronic timepiece as an example.

As illustrated in FIG. 1, the timepiece 1 includes a battery 2, an oscillating circuit 3, a frequency divider circuit 4, a control circuit 5, a pulse driving circuit 6, a stepping motor 7, and an analog timepiece unit 8.

The analog timepiece unit 8 includes a wheel train 11, an hour hand 12, a minute hand 13, a second hand 14, a calendar display section 15, a timepiece case 81, and a timepiece movement 82 (hereinafter, “movement 82”). In the present embodiment, the term “hand 16” will be used to refer to the hour hand 12, the minute hand 13, the second hand 14, and the calendar display section 15 when these need not to be specified.

The oscillating circuit 3, the frequency divider circuit 4, the control circuit 5, the pulse driving circuit 6, the stepping motor 7, and the wheel train 11 are constituting elements of the movement 82.

As a rule, the term “movement” is used to refer to the machinery of the timepiece, which includes various devices such as the time keeper of the timepiece 1. An electronic movement is also called a module. In a finished timepiece, for example, a dial and hands are attached to the movement, and the movement is housed inside the timepiece case.

The battery 2 is, for example, a lithium battery, or a button battery as it is also called. The battery 2 may be a storage battery that includes a solar cell, and that stores the power generated by the solar cell. The battery 2 supplies power to the control circuit 5.

The oscillating circuit 3 is a passive device that uses the piezoelectric phenomenon of, for example, quartz to produce a predetermined oscillating frequency from its mechanical resonance. Here, the predetermined frequency is, for example, 32 [kHz]

The frequency divider circuit 4 divides a signal of the predetermined output frequency from the oscillating circuit 3 into the desired frequency, and outputs the divided signal to the control circuit 5.

The control circuit 5 clocks time using the divided signal from the frequency divider circuit 4, and generates a drive pulse from the result of clocking. The control circuit 5 generates a drive pulse for forward rotation when rotating the hand 16 in forward direction. The control circuit 5 generates a drive pulse for reverse rotation when rotating the hand 16 in reverse direction. The control circuit 5 outputs the generated drive pulse to the pulse driving circuit 6.

In response to the drive instruction from the control circuit 5, the pulse driving circuit 6 generates a drive pulse for each hand. The pulse driving circuit 6 outputs the generated drive pulse to the stepping motor 7.

The stepping motor 7 moves the hand 16 (the hour hand 12, the minute hand 13, the second hand 14, the calendar display section 15) according to the output drive pulse from the pulse driving circuit 6. In the example of FIG. 1, for example, the stepping motor 7 is provided for each of the hour hand 12, the minute hand 13, the second hand 14, and the calendar display section 15.

The hour hand 12, the minute hand 13, the second hand 14, and the calendar display section 15 are moved by their respective stepping motors 7.

The hour hand 12 makes one rotation in 12 hours as a result of the pulse driving circuit 6 driving the stepping motor 7. The minute hand 13 makes one rotation in 60 minutes as a result of the pulse driving circuit 6 driving the stepping motor 7. The second hand 14 makes one rotation in 60 seconds as a result of the pulse driving circuit 6 driving the stepping motor 7. The calendar display section 15 is a hand for displaying, for example, dates, and makes one rotation in 24 hours as a result of the pulse driving circuit 6 driving the stepping motor 7.

The following describes an example of a schematic structure of the stepping motor 7 according to the present embodiment.

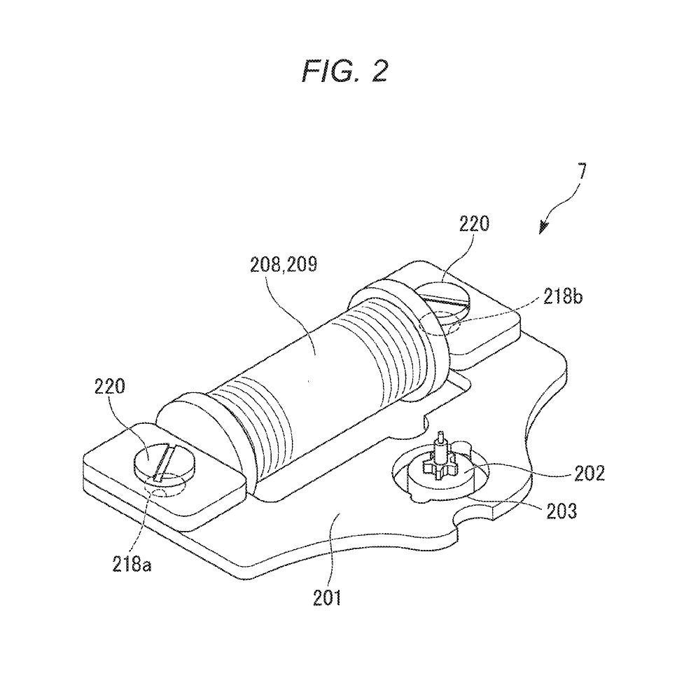

FIG. 2 is a perspective view showing an exemplary schematic structure of the stepping motor 7 according to the present embodiment. As illustrated in FIG. 2, the stepping motor 7 includes a stator 201, a rotor 202, a magnetic core 208, a coil 209, and screws 220.

The stator 201 has a rotor housing 203, a screw hole 218a, and a screw hole 218b.

The rotor 202 is rotatably disposed in the rotor housing 203.

The coil 209 is wound around the magnetic core.

When the stepping motor 7 is used for an analog electronic timepiece, the stator 201 and the magnetic core 208 are coupled to each other by being fastened to the base plate (not illustrated) of the movement 82 with the screws 220.

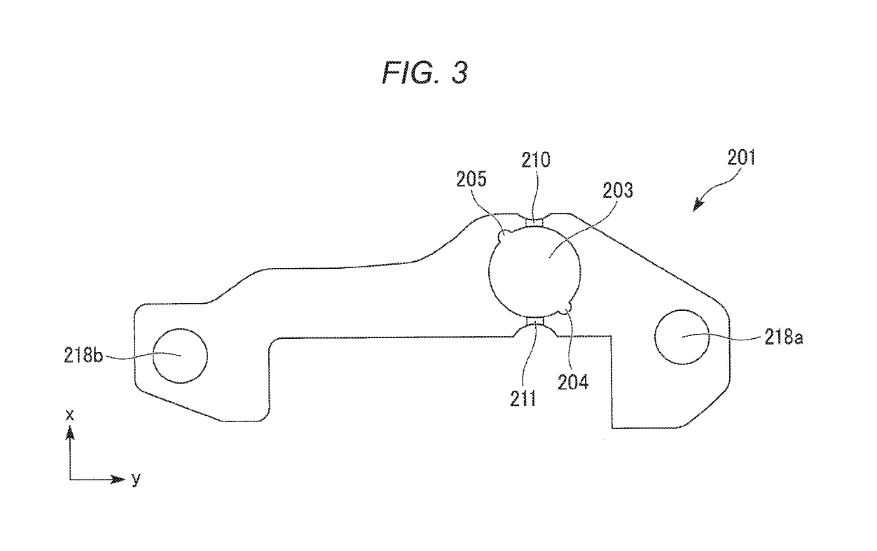

The stator 201 is described below with reference to FIG. 3.

FIG. 3 is a front schematic view of the stator 201 according to the present embodiment. In FIG. 3, the longer side and the shorter side of the stator 7 represents y-axis direction and x-axis direction, respectively. The stator 201 shown in FIG. 3 is produced by the method for producing a stator for motors described below. As illustrated in FIG. 3, the rotor housing 203 has grooves 204 and 205. The stator 201 also has narrow portions 210 and 211 formed at the circumference of the rotor housing 203. The stator 201 is formed of, for example, an Fe—Ni (iron-nickel) magnetic sheet material. The narrow portions 210 and 211 are non-magnetic regions.

When the stepping motor 7 is used for a timepiece, the stator 7 has the following dimensions, for example.

The rotor housing 203 has a hole diameter of about 1.5 to 2 mm. The narrow portions 210 and 211 have a width of about 0.1 mm in their narrowest portions. The stator 7 has a thickness of about 0.5 mm ± 0.1 mm. The length of the longer side is about 10 mm.

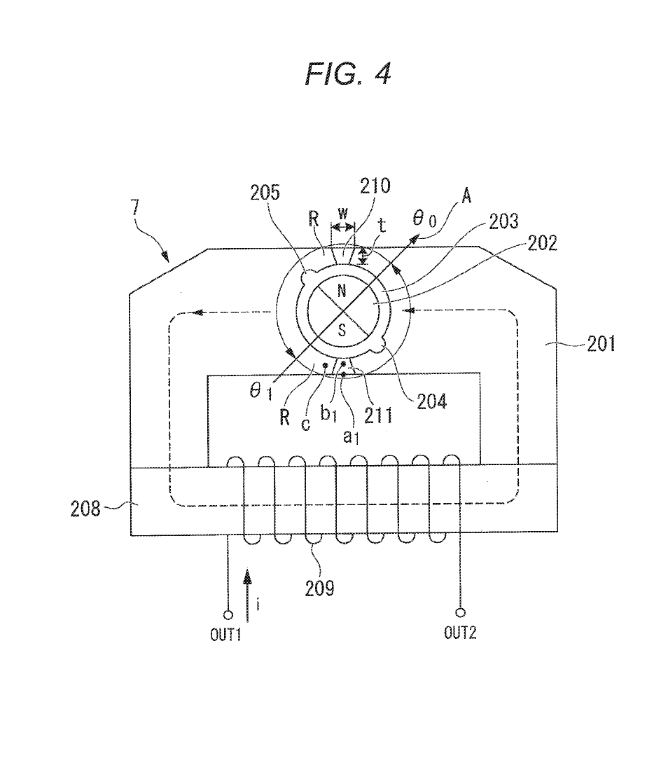

The stepping motor 7 according to the present embodiment is described below in greater detail using FIG. 4.

FIG. 4 shows a front schematic view of the stepping motor 7 according to the present embodiment.

The stepping motor 7 shown in FIG. 4 includes the rotor housing 203, the stator 201, the rotor 202, the magnetic core 208, the coil 209, and the narrow portions 210 and 211.

The stator 201 has a magnetic path R around the rotor housing 203. The rotor 202 is a bipolar rotor rotatably disposed in the rotor housing 203. The magnetic core 208 is joined to the stator 201. The coil 209 is wound around the magnetic core 208.

The narrow portions 210 and 211 are provided in portions that do not interfere with the grooves 204 and 205 that are provided for the rotor housing 203 for stable positioning of the rotor 202. The coil 209 has a first terminal OUT 1, and a second terminal OUT 2.

The rotor housing 203 is configured in the shape of a circular hole with a plurality of half-moon shape grooves (inner notches; two grooves, 204 and 205, in the example of FIG. 4) integrally formed at the opposing portions of the circular hole. The grooves 204 and 205 are configured as a locator for determining the stop position or the stable resting position of the rotor 202. For example, the groove (inner notch) 204 acts to stabilize the rotor position as the rotor moves to a predetermined position, and lowers its potential energy.

The rotor 202 is magnetized to have two poles (S pole, N pole).

When the coil 209 is not excited, the rotor 202 is in a position corresponding to the locator, as illustrated in FIG. 4. In other words, in an unexcited state, the rotor 202 is stably stopping (resting) at a position (angle θ₀) where the magnetic pole axis A of the rotor 202 is orthogonal to the segment connecting the grooves 204 and 205.

The narrow portions 210 and 211 (non-magnetic regions) are formed in a part of the magnetic path R (two locations in the example of FIG. 4) provided around the rotor housing 203. Here, the width in a cross section of the narrow portions of the stator 201 is cross sectional width t, and the width along the magnetic path is gap width w. The narrow portions 210 and 211 are formed in regions defined by the cross sectional width t and the gap width w.

In the following descriptions, a point on the outer circumference of the narrow portion 211 of the stator 201 is defined as point a₁, a point inside the narrow portion 211 is defined as point b₁, and a point in the vicinity of the narrow portion 211 and between the inner circumference and the outer circumference of the magnetic path R is defined as point c.

The method of production of the stator 201 will be described later.

The following describes the operation of the stepping motor 7 according to the present embodiment, with reference to FIG. 4.

First, the pulse driving circuit 6 supplies a drive pulse signal between the terminals OUT 1 and OUT 2 of the coil 209 (for example, the first terminal OUT 1 represents the positive electrode, and the second terminal OUT 2 represents the negative electrode), and current i is passed in the direction of the arrow in FIG. 4. This generates a magnetic flux in the stator 201 in the direction of the broken arrow.

In the present embodiment, the narrow portions 210 and 211 are formed as non-magnetic regions, and these regions have increased magnetic reluctance. There accordingly will be no need to magnetically saturate regions corresponding to traditional “narrow portions”, and a leakage magnetic flux can be provided with ease. As a result of the interaction between the induced magnetic pole of the stator 201 and the magnetic pole of the rotor 202, the rotor 202 rotates 180 degrees in the direction of arrow in FIG. 4, and the magnetic pole axis stably stops (comes to rest) at angle θ₁ position.

Here, the direction of the rotation driven by the stepping motor 7 for normal operation (the operation that moves hands in an analog electronic timepiece as in the embodiment of the present invention) is forward direction (counterclockwise direction in FIG. 4), and the rotation in the opposite direction (clockwise direction) is reverse direction.

Thereafter, the pulse driving circuit 6 supplies a drive pulse of opposite polarity to the terminals OUT 1 and OUT 2 of the coil 209 (opposite polarity from the driving polarity so that the first terminal OUT 1 represents the negative electrode, and the second terminal OUT 2 represents the positive electrode), and a current is passed in the opposite direction from that indicated by arrow in FIG. 4. This generates a magnetic flux in the stator 201 in a direction opposite the direction of broken arrow.

Because of the narrow portions 210 and 211 (non-magnetic regions), a leakage magnetic flux can be provided with ease as above, and the rotor 202 rotates 180 degrees in the same direction (forward direction), and the magnetic pole axis stably stops (comes to rest) at angle θ₀ position as a result of the interaction between the induced magnetic pole of the stator 201 and the magnetic pole of the rotor 202.

In this manner, the rotor 202 can continuously rotate 180 degrees in the direction of arrow in repeated operations every time a signal of different polarity (alternating signal) is supplied to the coil 209.

Because the narrow portions 210 and 211 (non-magnetic regions) are formed in a part of the magnetic path around the rotor housing 203, the magnetic flux consumed in these regions can greatly decrease, and the leakage magnetic flux for driving the rotor 202 can be efficiently provided.

The narrow portions 210 and 211 (non-magnetic regions) formed in portions corresponding to traditional “narrow portions” also have low magnetic permeability, and consume less magnetic flux generating from the rotor 202 itself. This makes it possible to prevent a loss of magnetic potential, and the rotor 202 can be magnetically put to a stop (a rest) and held with a stronger force.

Traditionally, the magnetic flux remaining after the rotor is brought to a “narrow portion” with a saturated magnetic flux from the OUT 1 side (negative electrode) needs to be cancelled before the rotor can be rotated from the OUT 2 side (positive electrode). In the present embodiment, however, the remaining magnetic flux in the narrow region is greatly reduced, and no time is needed for canceling of the remaining magnetic flux, making it possible to bring the rotation to a halt in a shorter time period. It is therefore possible in the present embodiment to maintain the operational stability for fast hand movement, allowing use of higher driving frequencies. The drive pulse that drives the stepping motor 7 will be described later.

### Method of Production

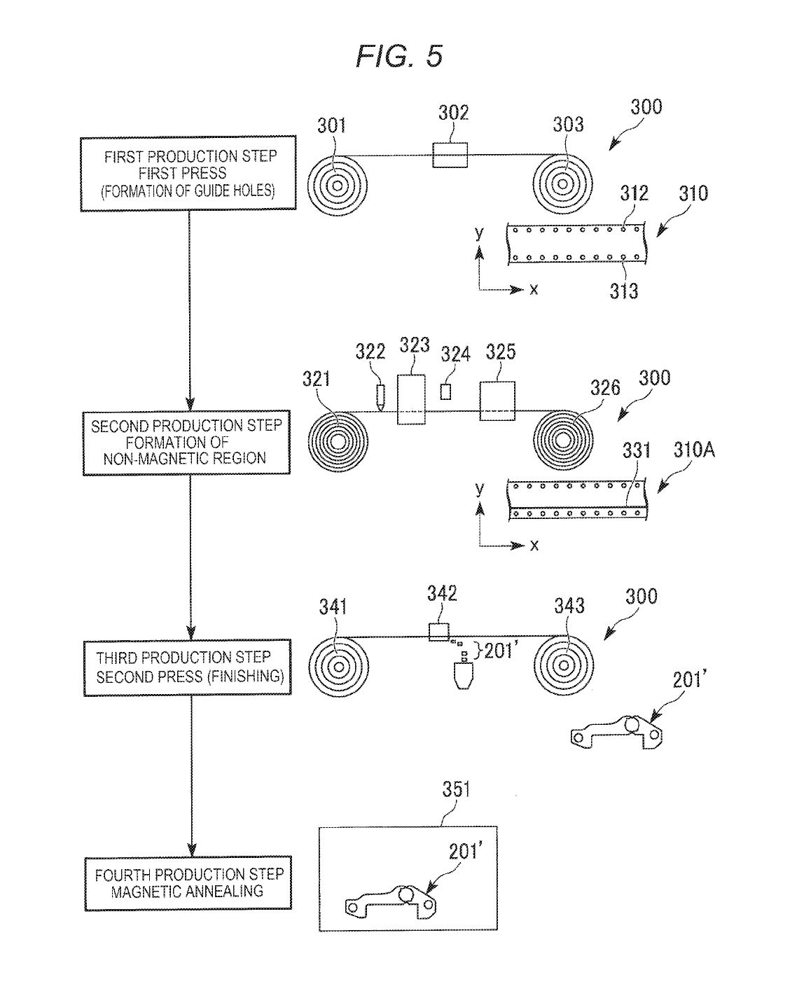

An exemplary method of producing the stator 201 is described below with reference to FIG. 5.

FIG. 5 is a diagram representing an example of a method for producing the stator 201 according to the present embodiment.

### First Production Step

### First Press (Formation of Guide Holes)

In a first production step, a production system 300 uses a pressing machine 302. Indicated by reference numeral 301 is a roll of hoop material 310 before pressing. Indicated by reference numeral 303 is a roll of hoop material after pressing. Indicated by reference numeral 310 is a top view of the hoop material after pressing. In FIG. 5, the longer side and the shorter side of the hoop material are x-axis direction and y-axis direction, respectively. The shorter side of the hoop material is, for example, 16.5 mm.

The pressing machine 302 forms registration guide holes 312 and 313 along the sides of a magnetic material (e.g., a 38 permalloy) provided in the form of a hoop material. After pressing, the production system 300 winds the pressed hoop material, as indicated by reference numeral 303.

### Second Production Step

### Formation of Non-Magnetic Region

In a second production step, the production system 300 uses a paste applicator 322 for applying a chromium (Cr) paste, a drier 323, a laser irradiator 324, and a washer 325. Indicated by reference numeral 321 is a roll of the pressed hoop material after the first production step. Indicated by reference numeral 326 is a roll of the hoop material 310 after the non-magnetic region was formed.

The paste applicator 322 applies a chromium paste to the desired y-axis positions of the hoop material. For example, the paste applicator 322 mixes chromium and a binder to make a paste, and dispenses the paste. That is, the paste applicator 322 is a dispenser. The desired y-axis position is a region where the narrow portions 210 and 211 (non-magnetic regions) of the stator 201 shown in FIG. 3 are to be formed. The paste applicator 322 applies a chromium paste to the desired positions, using the guide hole positions as a reference. Chromium is applied in a thickness of, for example, 150 to 200 [microns].

The drier 323 dries the applied chromium paste.

The laser irradiator 324 applies a laser beam to the chromium paste-applied region (reference numeral 331). The laser is preferably a fiber laser, which has a large depth of discharge. In response, the applied chromium melts into the base material (permalloy material). The applied chromium and the chromium inside the permalloy material diffuse and melt, and form a region with a chromium weight ratio of 15% or more. The laser irradiation creates a temperature equal to or greater than the melting point of chromium, specifically, 1,900 degrees or more, in the chromium paste-applied region. The laser beam has a diameter of about 0.3 to 0.5 mm on the incident side. The laser irradiator 324 applies a laser beam at, for example, 25 [microns] intervals in x-axis direction. In this way, the heat of laser irradiation on the base material (hoop material) can be reduced.

The washer 325 washes out the unnecessary chromium with a solvent. Indicated by reference numeral 310A is a top view of the hoop material after laser irradiation and washing. The non-magnetic region is indicated by reference numeral 331 in 310A. The non-magnetic region has a width of about 0.3 to 0.5 mm in y-axis direction. In this manner, in the second production step, the non-magnetic region is formed in a continuous straight line along the x-axis direction of the hoop material at the predetermined y-axis position. The washing is, for example, 5 minutes.

After washing, the production system 300 winds the hoop material having formed therein the non-magnetic region, as indicated by reference numeral 326.

### Third Production Step

### Second Press (Finishing)

In a third production step, the production system 300 uses a pressing machine (finishing machine) 342. Indicated by reference numeral 341 is a roll of the hoop material after the second production step. Indicated by reference numeral 343 is a roll of the hoop material after pressing.

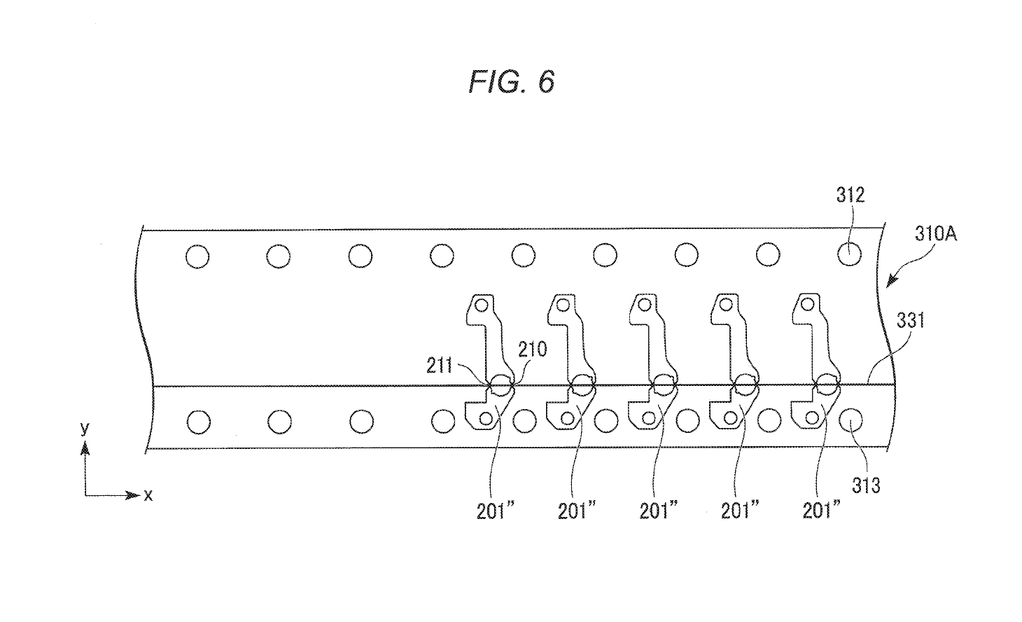

As illustrated in FIG. 6, the pressing machine 342 punches the hoop material in such a manner that the portions with a chromium weight ratio of 15% or more become the narrow portions 210 and 211 of the stator 201, using the positions of guide holes 312 and 313 as a reference. FIG. 6 is a top view of the hoop material 310A before pressing of the stator 201 according to the present embodiment. The stator 201′ represents a stator before the fourth production step. In FIG. 6, the position of the stator 201′ to be pressed is indicated by reference numeral 201″. The punching punches portions of the non-magnetic region 331 in a shape that surrounds the rotor 202 for stepping motor 7. That is, the third production step forms the rotor housing 203 at the same time.

This completes the outer shape of the stator 201′ having a different chromium weight ratio for the narrow portions and other portions.

### Fourth Production Step

### Magnetic Annealing

In a fourth production step, the production system 300 uses an annealing furnace 351.

With the annealing furnace 351, the stator 201′ is subjected to high-temperature annealing. This process removes or relieves the residual stress due to the press working of the third production step.

The production system 300 produces the stator 201 shown in FIG. 3 through the first to fourth production steps described above.

With the stator 201 produced in the foregoing process, it is possible to reduce the heat deformation due to laser irradiation at the time of forming the non-magnetic region.

### Exemplary Pictures of Hoop Material Cross Section after Laser Irradiation

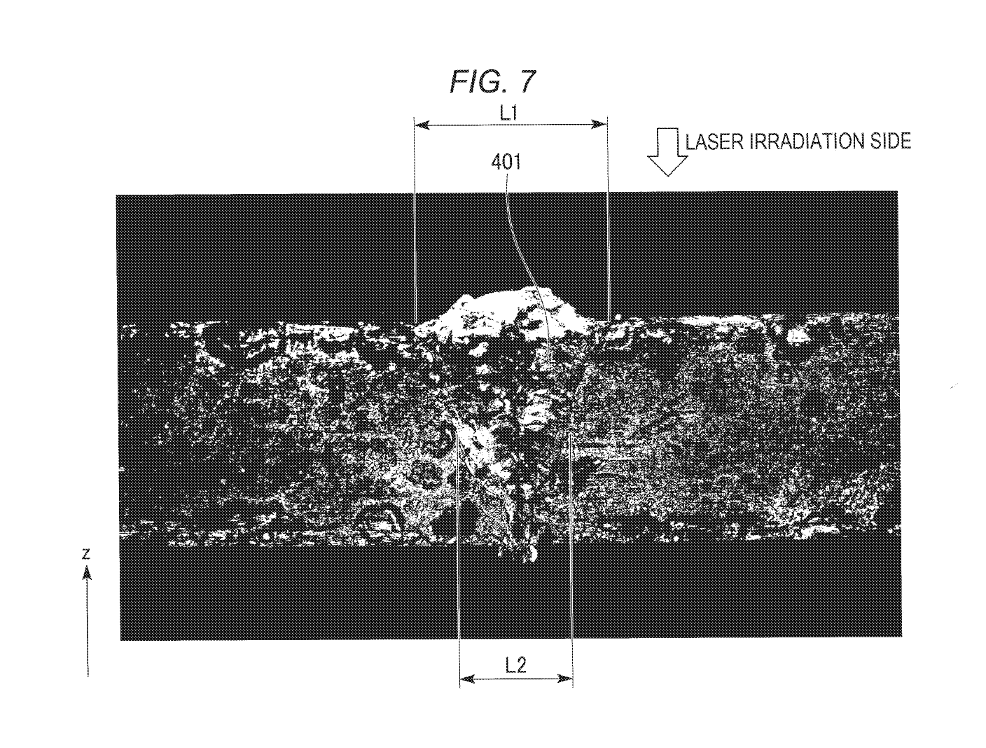

FIGS. 7 to 9 shows examples of pictures of cross sections of a permalloy hoop material after the chromium applied to one side of the hoop material was irradiated with a laser beam to melt and diffuse, and create a chromium concentration of 15 weight % or more. The cross section pictures of the permalloy hoop material shown in FIGS. 7 to 9 were taken after the chromium applied to the hoop material was irradiated with a laser beam to melt and diffuse, and create a chromium concentration of 15 weight % or more according to the embodiment.

In FIGS. 7 to 9, the vertical direction (z-axis direction) is the thickness direction of the hoop material. The laser is applied from the chromium-applied surface (top surface). The hoop material has a thickness of, for example, 0.5 mm ± 0.1 mm. In FIGS. 7 to 9, a portion melted by laser irradiation is indicated by reference numeral 401.

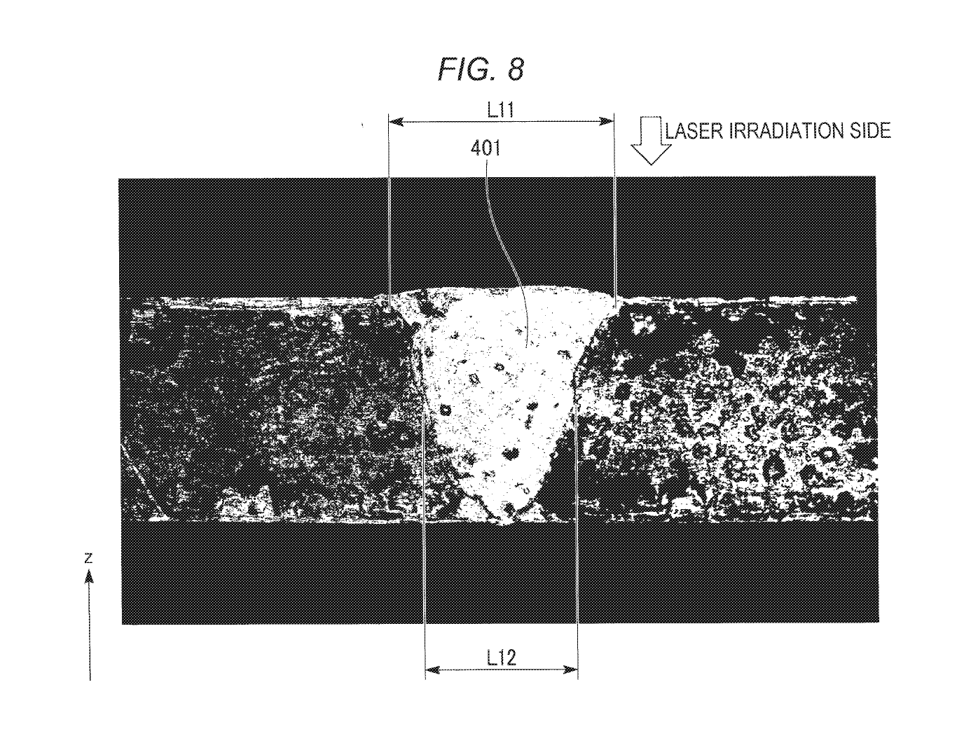

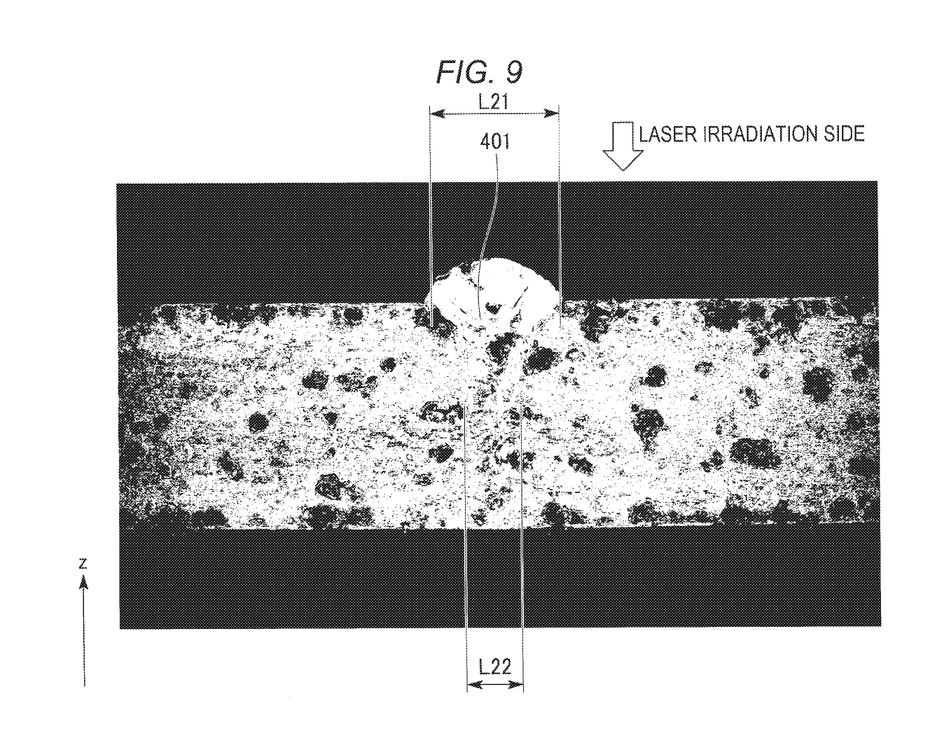

FIG. 7 is an example in which the molten portion 401 penetrates through the material from top surface to bottom surface. FIG. 8 is an example in which the molten portion 401 reaches the bottom surface. FIG. 9 is an example in which the molten portion 401 does not reach the bottom surface.

In FIGS. 7 to 9, the width of the molten portion on the laser irradiation side is indicated by reference numerals L1, L11, and L21. The width of the molten portion at a half-thickness position of the hoop material is indicated by reference numerals L2, L12, and L22.

As shown in FIGS. 7 to 9, the molten portion produced by the method of the present embodiment is wider on the laser incident side than in non-surface portions along the thickness of the hoop material. The molten portion is also narrower from one side (upper side) of the hoop material (magnetic sheet material) toward the other side (lower side) in the thickness direction of the material, and the cross sectional area becomes smaller in this direction.

The chromium concentration of the molten portion is 15 mass % or more, and the molten portion is formed as a non-magnetic region in all of the examples shown in FIGS. 7 to 9.

### Result of EDS Line Analysis

The following describes the result of an EDS line analysis of a molten portion produced according to the method of the present embodiment.

First, an EDS (Energy Dispersive X-ray Spectroscopy) line analysis is briefly described.

A beam of incident X-rays on a device creates a charge that is proportional to the energy of the X-rays. An analyzing device used for EDS line analysis causes these charges to accumulate in, for example, the gate electrode of a field-effect transistor, and converts it into a current in proportion to the amount of charge. The analyzing device then converts a current change into a pulse for different X-rays, and measures the number of pulses (X-ray count) for each pulse height using a pulse height analyzer. From the measured result, the analyzing device creates a spectrum by taking the energy value (keV) of X-rays on the horizontal axis, and the X-ray count on the vertical axis (see, for example, Reference Document 1).

Reference Document 1: What is EDS Analysis? Tips for Better Analysis (Basics of EDS Analysis), Iwao Yamasaki, Bruker AXS Co., Ltd., 2014, https://www.bruker.com/fileadmin/user_upload/8-PDF-Docs/X-rayDiffraction_ElementalAnalysis/Microanalysis_EBSD/Webinars/Bruker_Japanese_Webinar_2014-11-25_EDS_Feature_Analysis.pdf#search=%27%EF%BC%A5%EF%BC%A4%EF%BC%B3%E3%83%A9%E3%82%A4%E3%83%B3%E5%88%86%E6%9E%90%27 (Internet search: 2017.9.10)

The analyzing Device, and analysis conditions are described below.

An observed cross section of the narrow portions 210 and 211 was polished (CP) with an IB-09020CP (a trade name; available from JEOL). The acceleration voltage was set to 7 kV.

For scanning electron microscopy, a field-effect scanning electron microscope (FE-SEM) (available under the trade name JSM-7800F from JEOL) was used.

The JEOL product IB-9020CP was used for ion milling of a sample, after resin embedding and polishing.

The sample was measured for the cross section created by ion milling {Ar (argon) ions, acceleration 7 kV}.

Measurement was made in a vacuum of 10⁻⁴ to 10⁻⁵ Pa.

An EDS line analysis was performed under an applied voltage of 15 kV, using a NORAN SYSTEM 7 (trade name) Ver. 3 available from Thermo Fisher Scientific Inc.

An example of the result of an EDS line analysis of the molten portion is described below.

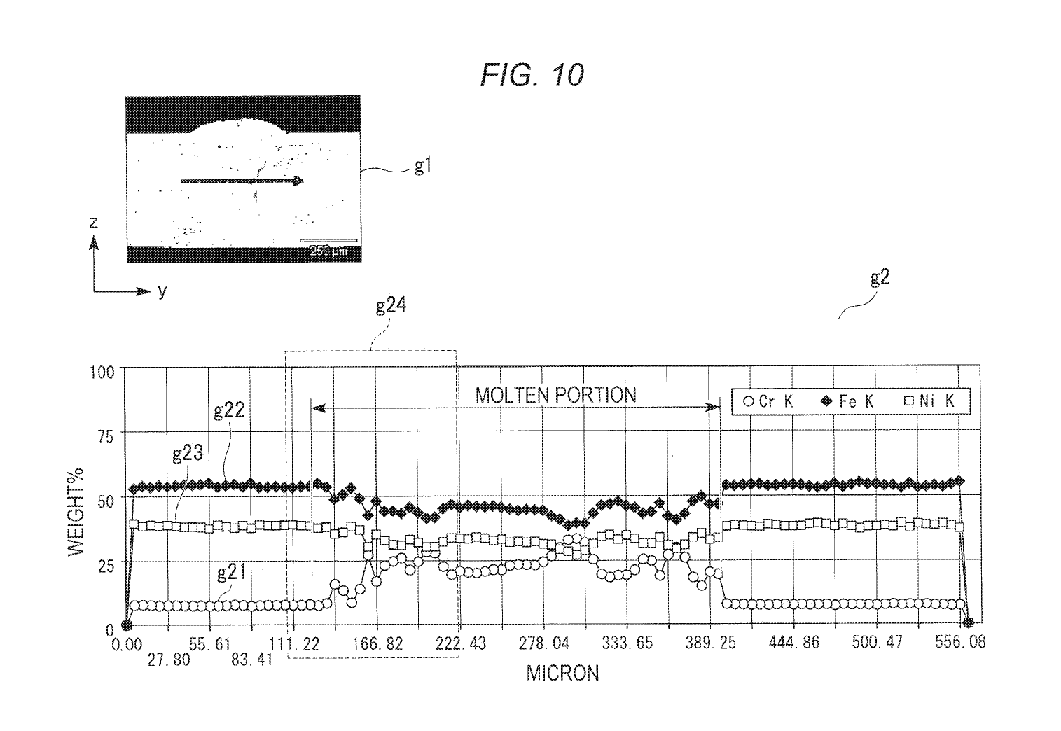

FIG. 10 is a diagram representing an example of the result of an EDS line analysis of the molten portion according to the present embodiment. In FIG. 10, the diagram indicated by reference numeral g1 shows the molten portion studied by EDS line analysis. The y-axis direction represents the longer side of the stator 201, as shown in FIG. 3. The image shown in the diagram indicated by reference numeral g1 shows the molten portion as observed under a reflection microscope. The magnification is 120 times. The diagram indicated by reference numeral g2 is a graph representing the result of line analysis. The horizontal axis represents position [microns], and the vertical axis represents mass [%]. Reference numeral g21 represents changes in the mass [%] of Cr (chromium) with distance. Reference numeral g22 represents changes in the mass [%] of Fe (iron) with distance. Reference numeral g23 represents changes in the mass [%] of Ni (nickel) with distance. The region surrounded by broken lines g24 is a region where chromium shows mass changes.

In FIG. 10, the molten portion is a zone from about 140 [microns] to 400 [microns]. The mass of chromium is about 20 to 28% in this zone. Because the mass of chromium is 15 mass % or more in this region, the region is paramagnetic at ordinary temperature, and corresponds to the point b₁ shown in FIG. 4. Here, “paramagnetic” refers to magnetism whereby the material is not magnetized in the absence of an external magnetic field, and is magnetized under an applied magnetic field in the direction of the applied magnetic field. Being “paramagnetic” at ordinary temperature is synonymous with a non-magnetic state. The iron (Fe) in this region is about 41 to 51 mass %, and the nickel (Ni) is about 30 to 38 mass %.

In the Fe—Ni—Cr alloy, the alloy is ferromagnetic at ordinary temperature when it is a 38 permalloy with 54 mass % Fe, 38 mass % Ni, and 8 mass % Cr. Here, “ferromagnetic” means the magnetism of a substance with a magnetic moment.

In FIG. 10, the mass of chromium is about 8 mass % in an about 140 [microns] region from the outer edge, and in a region of 400 [microns] and more. In these regions, the chromium is about 7 to 8 mass %, about the same as the mass of the Cr component of a 38 permalloy, and represents a ferromagnetic region. These regions correspond to the point b₁ and the point c of FIG. 4.

As described above, the stator 201 produced through the production steps of the present embodiment has a paramagnetic region with 15 mass % or more of chromium, ferromagnetic regions with 7 to 8 mass % chromium, and a region where chromium shows large mass changes (the region surrounded by broken lines g24 in FIG. 10). That is, the stator 201 produced through the production steps of the present embodiment has a non-magnetic region (point b₁ in FIG. 4). In the stator 201, the Cr content X % in the molten portion differs from the Cr content Y % in other regions by 6% or more (X−Y≥6), and the Cr concentration of the molten portion is higher than in the base material.

As shown in FIG. 10, the chromium concentration of the non-magnetic molten region is 6 weight % to 18 weight % higher relative to the Cr concentration of 8 weight % in regions of the magnetic sheet material other than the non-magnetic molten region.

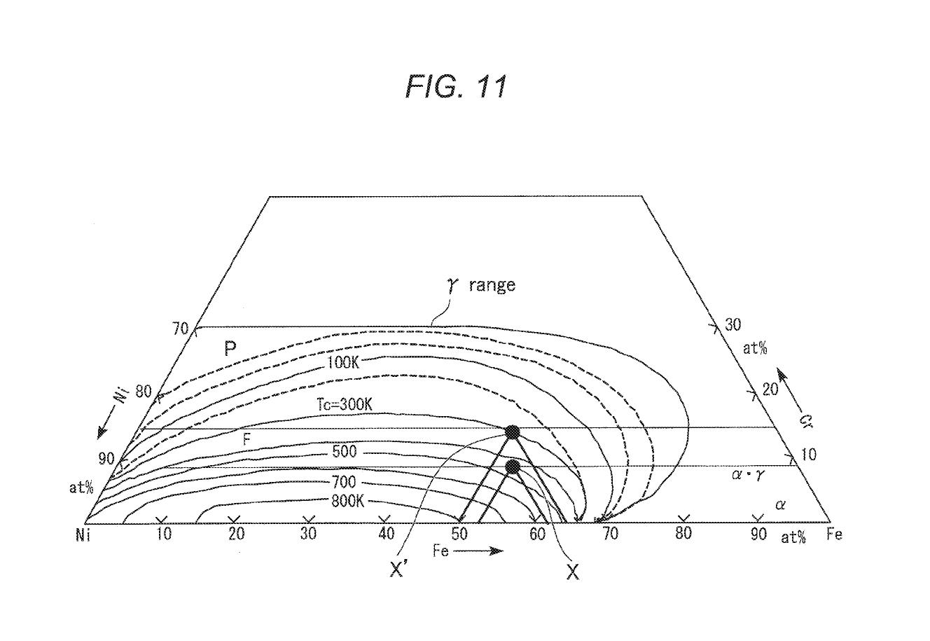

In the stepping motor 7 according to the present embodiment, the stator 201 is configured from an Fe—Ni alloy. Preferably, the Fe—Ni alloy is one having high magnetic permeability. The 38 permalloy is an example of such an Fe—Ni alloy. Referring to the phase diagram of FIG. 11, the Curie temperature of Fe-38%Ni-8%Cr is 500 K or more (point X). In a region where chromium is 15 mass % or more, the Curie temperature is 300 K, and an austenite phase occurs at ordinary temperature (point X′). FIG. 11 is a ternary alloy phase diagram of Fe—Ni—Cr. Specifically, in the vicinity of ordinary temperature where driving of the stepping motor 7 takes place, a non-magnetic state can be ensured for the stator 201 with 15 mass % or more of chromium. Of note, the phase diagram shown in FIG. 11 was cited from paragraph 188 of Ternary Alloys Between Fe, Co or Ni and Ti, V, Cr or Mn (Landolt-Bornstein new Series III/32A).

### Current through Coil 209 of Stepping Motor 7

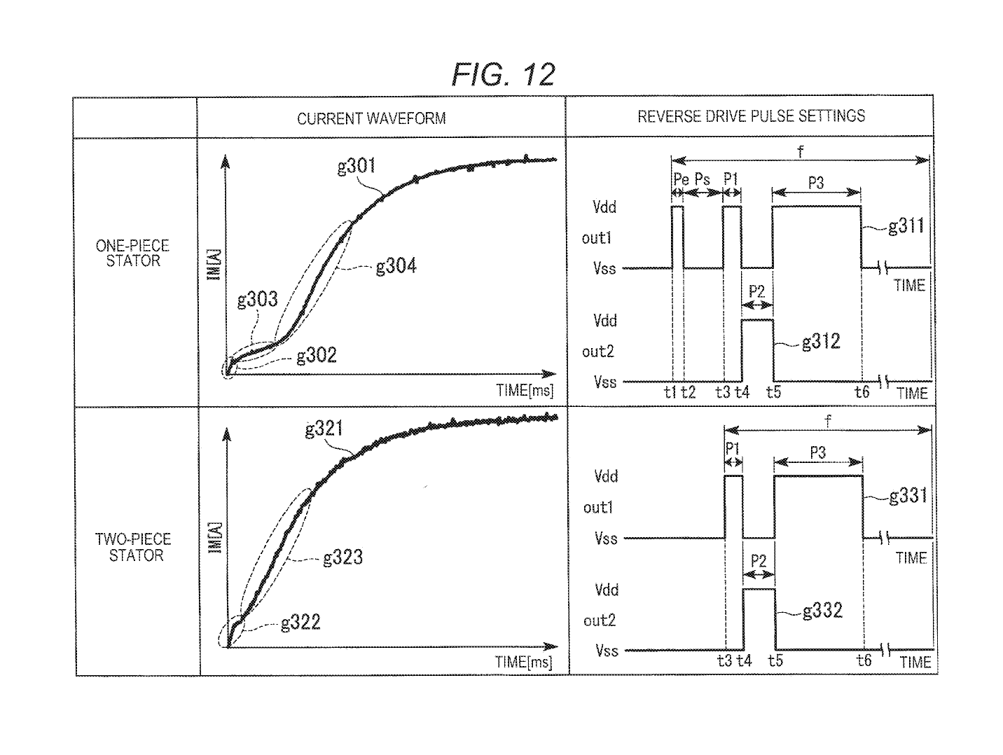

The following describes the current that flows through the coil 209 of the stepping motor 7, with reference to FIG. 12.

The following describes examples of current changes (current I) against time (time t) with reference to FIG. 12, using a common integrated stator (also called a one-piece stator) and a separate stator (also called a two-piece stator) of a stepping motor. FIG. 12 is a diagram representing examples of current waveforms of an integrated stator and a separate stator, and examples of drive pulses for reverse rotation. The waveform g301 is a waveform of current undergoing changes with time in the integrated stator. The waveform g321 is a waveform of current undergoing changes with time in the separate stator. In the waveforms g301 and g321, the horizontal axis represents time, and the vertical axis represents the current flowing in the coil. A stepping motor having the integrated stator has the same configuration as the stepping motor 7 of FIG. 4, except that the molten portion is absent in the narrow portions 210 and 211.

The waveform g301 shown in the figure has a plurality of different slope periods, as indicated by the regions surrounded by broken lines g302 to g304. In the present embodiment, the region surrounded by broken line g302 is a first slope period, the region surrounded by broken line g303 is a second slope period, and the region surrounded by broken line g304 is a third slope period.

The first slope period is a period that depends on the self inductance L of the coil of the stepping motor. In this period, the generated magnetic flux from the coil flows in the stator.

In the second slope period, the magnetic flux flows in areas of low magnetic reluctance, and the magnetic flux generated from the coil in the first slope period flows in the narrow portions in the second slope period. The magnetic flux in the narrow portions becomes saturated in the presence of a predetermined current flow. In other words, the second slope period is a period in which the magnetic flux of the narrow portions is saturated.

In the third slope period, the magnetic flux saturated in the narrow portions in the second slope period leaks into the rotor housing. In other words, the third slope period is a period in which the rotor starts moving.

In a stepping motor having the integrated stator, the rotor starts rotating as the repulsion force of the magnetic flux acts on the rotor in the third slope period.

A stepping motor having the separate stator has a first slope period surrounded by broken line g322, and a third slope period surrounded by broken line g323, as indicated by waveform g321. That is, a stepping motor having the separate stator does not have the second slope period. Accordingly, the separate stator does not require a period that magnetically saturates the magnetic flux.

The following describes examples of drive pulses for reverse rotation, using a stepping motor with the integrated stator, and a stepping motor with the separate stator.

In FIG. 12, the waveform g311 and the waveform g312 are driving pulse waveforms used for reverse rotation of a stepping motor having the integrated stator. The waveforms g331 and g332 are driving pulse waveforms used for reverse rotation of a stepping motor having the separate stator. In the waveforms g311, g312, g331, and g332, the horizontal axis represents time, and the vertical axis represents signal level. The terminals of the coil of the stepping motor are represented by out 1 and out 2. Vdd is, for example, a power supply voltage of the drive circuit that drives the stepping motor. Vss is 0 V, or a reference voltage.

To describe the drive pulse of the stepping motor having the integrated stator, a drive pulse of width Pe is input to out 1 of the coil during the time period of t1 to t2 to cancel the magnetic flux remaining in the narrow portions of the stator from the previous driving, as indicated by waveforms g311 and g312. From time t3 to t4 following the predetermined time period Ps after time t2, a drive pulse of width P1 is input to out 1 of the coil to move the rotor by a small angle in forward direction. The period Ps is a standby time provided for the rotor to return to the original position after the input of a drive pulse in period Pe. From time t4 to t5, a drive pulse of width P2 is input to out 2 of the coil to move the rotor by a small angle in reverse direction. From time t5 to t6, a drive pulse of width P3 is input to out 1 of the coil to move the rotor by a small angle in reverse direction.

If the driving begins with the input of a drive pulse of width P1 at time t3 without an input of a drive pulse of width Pe to out 1 of the coil, the rotor operation becomes unstable because of the remaining magnetic flux. That is, for reverse rotation, a stepping motor having a common integrated stator requires a time period for a drive pulse of width Pe for canceling of the remaining magnetic flux, and the standby period Ps in a frame f, which is a time period to move a hand by one step.

The period Ps is, for example, 5 to 6 [ms], and the total of width P1, width P2, and width P3 is, for example, 10 to 15 [ms]. The time before the rotor returns to the rest position after being driven with a drive pulse of width P3 is, for example, about 5 [ms], as is the standby period. In this case, the total length of one frame f is 20 (=5+10+5) to 26(=6+15+5) [ms]. For example, when one frame is 32 [Hz], the time length is 31.25 [ms]. For reverse rotation, a stepping motor having an integrated stator thus operates in a cycle of 32 [Hz] per frame. Accordingly, reserve rotation requires a time period for a drive pulse of width Pe, and the period Ps. This has created a technical barrier that prevents use of a frequency higher than 32 [Hz] for reverse rotation.

In reverse rotation using a stepping motor having a separate stator, a frame f is a total of width P1, width P2, and width P3 plus the time required for the rotor to return to the rest position, and is, for example, 20 (=15+5) [ms], as indicated by waveforms g331 and g332. This allows a stepping motor having a separate stator to adopt a shorter frame, for example, 50 [Hz], for reverse rotation than in a stepping motor having an integrated stator.

Despite these advantages, a separate stator is essentially an assembled unit of completely separate mechanical structures, and the rest position is unstable due to a misalignment as might occur during assembly. This makes it difficult to use a separate stator in a stepping motor in certain applications such as in wristwatches. In a stator with such a mechanically separated structure, two divided stator units are prepared by machining, and these are welded together to make a stator. The stator is therefore prone to strains or a parts misalignment due to mechanical stress or welding. Because of this, the separate stator involves a distance error between the rotor and the stator.

The following describes a comparative example intended to solve the problems of the separate stator.

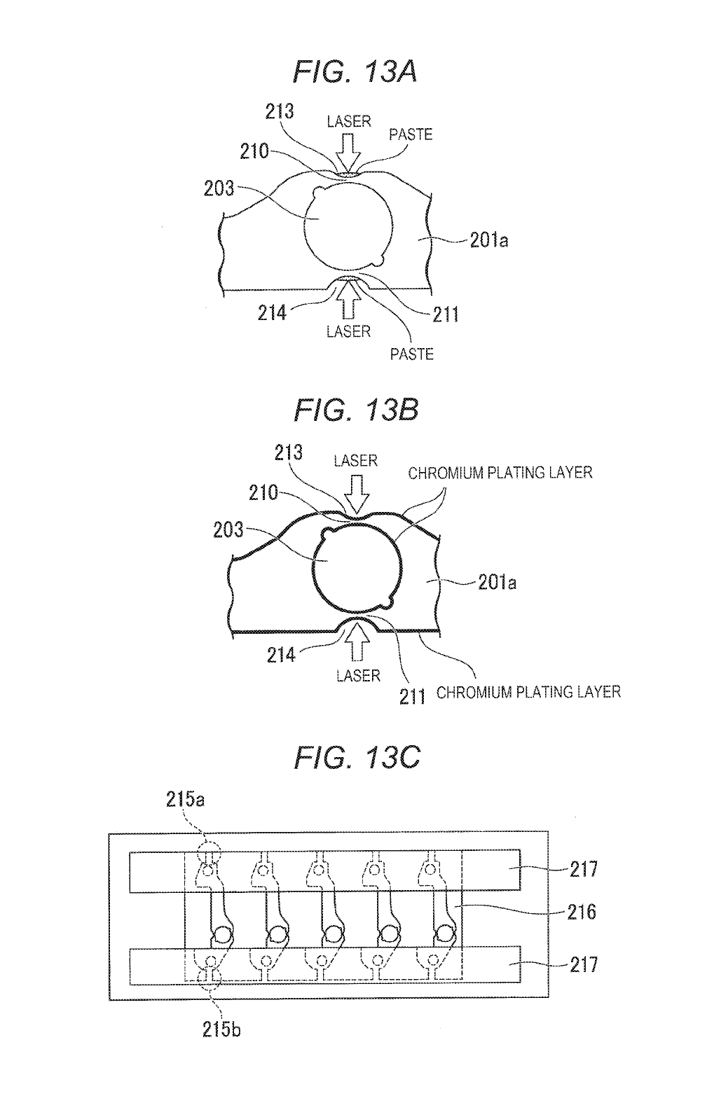

FIGS. 13A and 13B are diagrams describing the technique used to produce a stator of Comparative Example. FIG. 13C is a diagram showing a hoop material cut at the time of plating in Comparative Example.

In Comparative Example (see JP-A-2016-136830), an Fe—Ni alloy sheet is machined such as by punching (press working) to form a stator material having a rotor housing 203, and a magnetic path R formed around the rotor housing 203. The grooves (inner notches) 204 and 205 also may be formed in this step. The stator material 201a is preferably an Fe—Ni alloy having high magnetic permeability, for example, Fe-38%, Ni-8%Cr (i.e., a 38 permalloy).

A Cr material to be melted and diffused is placed on at least a part of the stator material 201a, and a laser is applied to the Cr material to melt and diffuse the Cr material inside the magnetic path R, and form narrow portions 210 and 211. Specifically, for example, a paste containing powdery metal chromium may be applied to at least a part of the magnetic path, and irradiated with a laser beam to melt and diffuse. Alternatively, a chromium plating layer may be formed in advance on a surface of the stator material 201a, and a part of the chromium plating layer, specifically, the chromium plating layer formed in at least a part of the magnetic path R may be irradiated with a laser beam to melt and diffuse. In the case of plating, the mass percentage of chromium is kept below 80%, taking into consideration, for example, the coatability of the stator base material. A powder may be used, instead of a paste. In the case of plating, the hoop material 216 is cut into a strip form of a size that can be placed in a plating tank, with a part of the stator material 201a (215a, and 215b) attached to the hoop material 216, as shown in FIG. 13C. A mask 217 is applied to areas where plating is not desired.

The narrow portions 210 and 211 are formed by forming the paste or the chromium plating layer in the grooves (outer notches) 213 and 214, as shown in FIGS. 13A and 13B.

The rotor 202 is disposed inside the rotor housing 203 of the stator material 201a obtained after the formation of the narrow portions 210 and 211 (Cr diffused regions), and a magnetic core is fixed to the stator material 201a, using a selected fixing means. A coil is then wound around the magnetic core to complete the stepping motor.

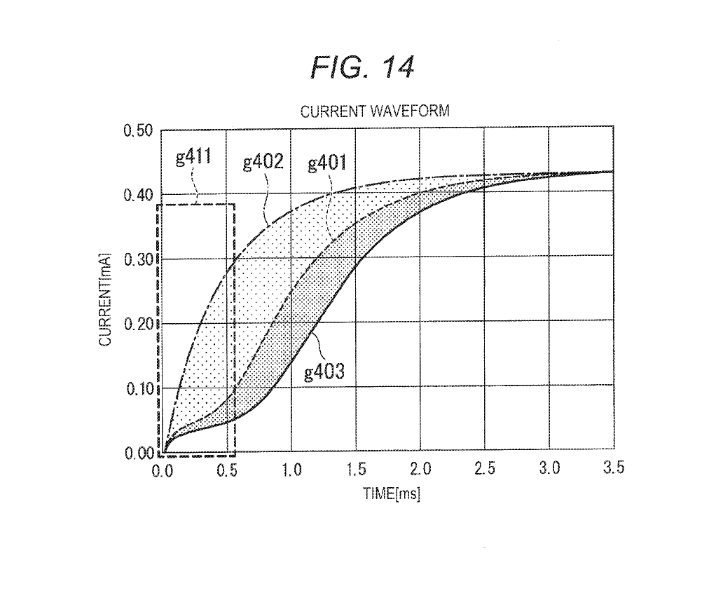

FIG. 14 is a graph representing changes in the current value of the coil against time in three types of stators. In other words, FIG. 14 represents the saturation characteristics. In FIG. 14, the vertical axis represents the current value (mA) of coil 209, and the horizontal axis represents time (msec). The graph was obtained without the rotor, in order to eliminate the influence of the magnetic flux from the rotor magnet, and to check the saturation state only with the magnetic flux generated by the coil. The three stators are a first stator prepared by, for example, diffusing chromium in the narrow portions 210 and 211 at 1,200° C. for 1 hour in a helium inert gas atmosphere; a second stator prepared by, for example, diffusing chromium in the narrow portions 210 and 211 at 1,200° C. for 24 hours in a helium inert gas atmosphere; and a third stator prepared by plating chromium on the base material, without diffusing chromium at 1,200° C.

The waveform g401 represents current changes with time for the first stator. The waveform g402 represents current changes with time for the second stator. The waveform g403 represents current changes with time for the third stator.

As indicated by waveform g403, the third stator has three slope periods, as with the case of the common integrated stator indicated by waveform g301 of FIG. 12. For example, the third stator has a first slope period of from 0 to about 0.05 [ms], a second slope period of from about 0.05 to 0.7 [ms], and a third slope period of from about 0.7 to 1.7 [ms].

The waveform g401 of the first stator prepared by diffusing chromium for 1 hour has three slope periods. For example, the first stator has a first slope period of from 0 to about 0.05 [ms], a second slope period of from about 0.05 to 0.5 [ms], and a third slope period of from about 0.5 to 1.2 [ms].

The waveform g402 of the second stator prepared by diffusing chromium for 24 hours has two slope periods, as with the case of the common separate stator indicated by waveform g321 of FIG. 12. For example, the second stator has a first slope period of from 0 to about 0.05 [ms], and a third slope period of from about 0.05 to 0.5 [ms].

As can be seen in FIG. 14, the stators prepared by diffusing chromium in the narrow portions 210 and 211 can have improved saturation characteristics as compared to the third stator prepared without diffusing chromium in the narrow portions 210 and 211.

It is to be noted that the slope regions, and the time and width of slope regions are merely examples, and are given solely for the purpose of explanation.

In Comparative Example, the paste or the chromium plating layer is formed in the grooves (outer notches) 213 and 214 of the component punched in a shape of a stator. In Comparative Example, a chromium paste is applied in the thickness direction of the sheet, and melted by laser irradiation after application, as shown in FIG. 13A. Here, about 2 hours of plating time are needed to obtain a plating thickness of 20 [microns]. In such a melting procedure, the hoop material needs to be cut into a size (for example, the longer side is 90 mm long) that can be placed in a plating bath, when the hoop material is subjected to a first press that does not fully cut the stator in the hoop material. Accordingly, it is difficult with Comparative Example to produce a stator using a long hoop material. The plating requires plating the necessary amount of chromium from both sides, and applying a laser through it. The plating of Comparative Example also requires a time consuming step of detaching the Cr plating from unnecessary portions in a plating bath. In Comparative Example, a laser is applied to the narrow portions 210 and 211 of a narrow width, and there is a risk of the rotor housing 203 deforming under the applied heat.

In the present embodiment, a chromium paste is applied to the desired thickness position of the sheet using the guide holes as a reference, before punching the stator 201. In the present embodiment, this is followed by laser irradiation in sheet thickness direction. In the present embodiment, the sheet is then punched to produce the stator 201, using the guide holes as a reference.

The stator 201 produced with the method of the present embodiment can have improved saturation characteristics, as with the case of the second stator of FIG. 14 produced by diffusing chromium in the narrow portions 210 and 211 for 24 hours.

In the present embodiment, because the stator 201 is punched after forming the molten portion by laser irradiation, the stator 201 can be prevented from deformation during production. The present embodiment thus enables stable production of the stator 201 with an accurate shape. In the present embodiment, because chromium is applied in the thickness direction of the stator 201 to form the molten portion, the molten portion has an increased cross sectional area as shown in FIGS. 7 to 9. This increases the flexural strength, and deformation due to handling can be prevented. In the present embodiment, unnecessary portions of the chromium paste melted by a laser can easily be removed with a solvent. In the present embodiment, chromium can be supplied from one side in amounts necessary for unmagnetization.

In the present embodiment, the stator is a magnetically separate stator, and is less affected by, for example, the remaining magnetic flux that occurs in a common integrated stator in the narrow portions as a result of reverse rotation of the stator. In the present embodiment, the width P3 can thus be made shorter than that shown in FIG. 12. For example, when the total time length of width P1, width P2, and width P3 plus the rest period after width P3 is 15 [ms], the hand can be rotated in reverse direction two times faster than in the related art, specifically, in a cycle of 64 [Hz] per frame. That is, the present embodiment enables fast rotation at 64 [Hz] by breaking the technical barrier of a stepping motor using an integrated stator in which the hands are reversely rotated at 32 [Hz] per frame.

### Comparison of Stator Rotor Housing in the Presence and Absence of Deformation

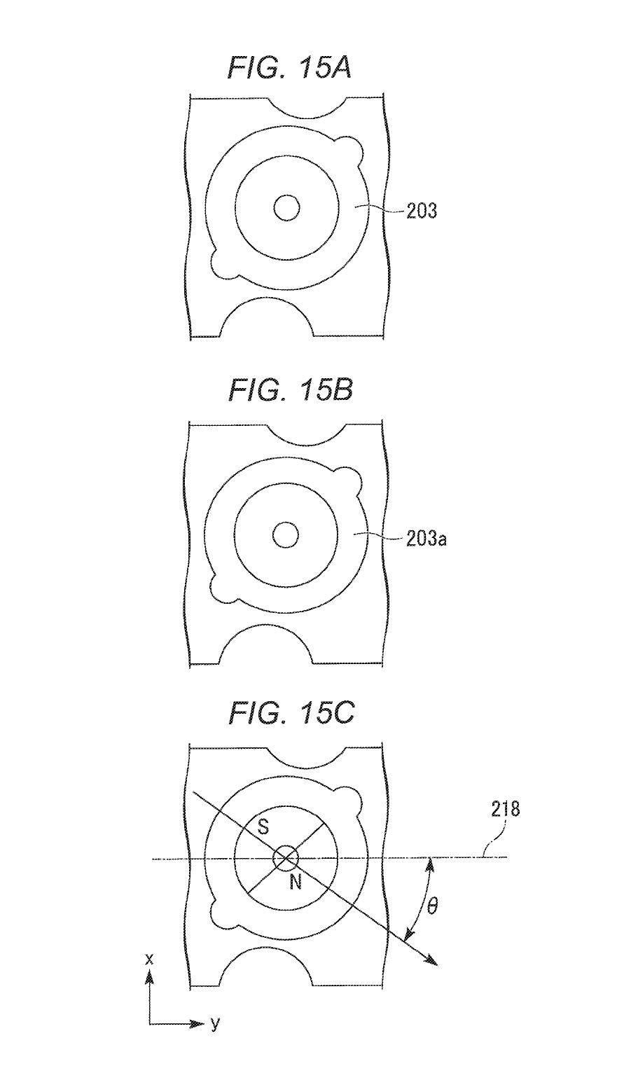

The following describes the rotor housing of the stator in the presence and absence of deformation, using FIGS. 15A to 18C.

FIG. 15A is a diagram showing the rotor housing in the absence of deformation. FIG. 15B is a diagram showing the rotor housing in the presence of deformation. FIG. 15C is a diagram describing the horizontal axis of the stator, and the static angle θ of the rotor.

As shown in FIG. 15A, in the absence of deformation, the rotor housing 203 is a substantially true circle with a hole diameter ϕ of 1.8 mm. In the presence of deformation, the rotor housing 203a has a hole diameter of about 1.8 mm horizontally, and about 1.7 mm vertically, as shown in FIG. 15B. In FIG. 15C, the dashed-dotted line 218 in horizontal direction (y-axis direction) represents the stator horizontal axis, and the angle θ represents the direction of a magnetic pole axis with respect to the stator horizontal axis 218 in an unexcited state. In the following descriptions, the angle θ is the rotor static angle θ.

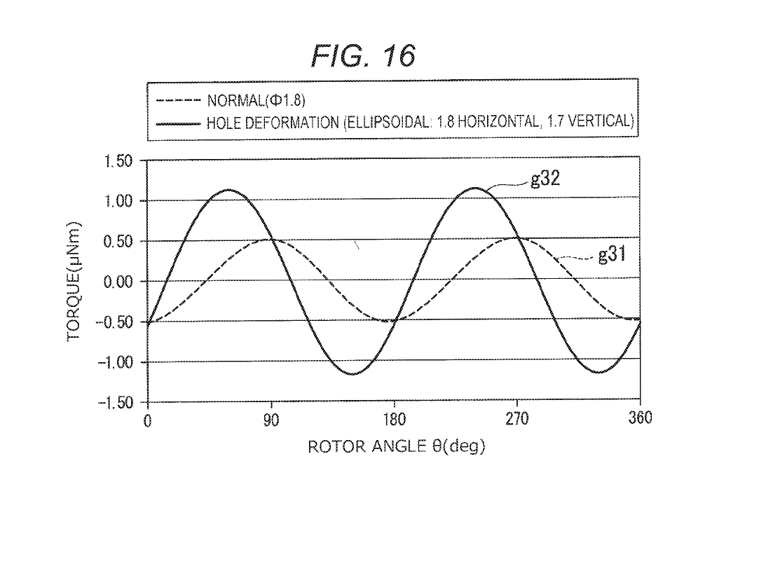

FIG. 16 is a diagram representing changes in torque with rotor angle in the presence and absence of deformation in the rotor housing. In FIG. 16, the horizontal axis represents rotor angle [deg], and the vertical axis represents torque [μNm]. The waveform g31 indicates changes in the absence of deformation in the rotor housing 203. The waveform g32 indicates changes in the presence of deformation in the rotor housing 203a.

As shown in FIG. 16, the rotor static angle θ is about 40° in the absence of deformation in the rotor housing 203. The rotor static angle θ is a rotor angle of when the torque is almost zero.

The rotor static angleθ is about 10° in the presence of deformation in the rotor housing 203a.

The cogging torque (potential energy) is about 0.5 [μNm] in the absence of deformation in the rotor housing 203. The cogging torque is the maximum torque value.

The cogging torque is about 1.1 [μNm] in the presence of deformation in the rotor housing 203a.

The following describes examples of the cogging torque, the stored energy, and the integral torque with respect to the rotor angle.

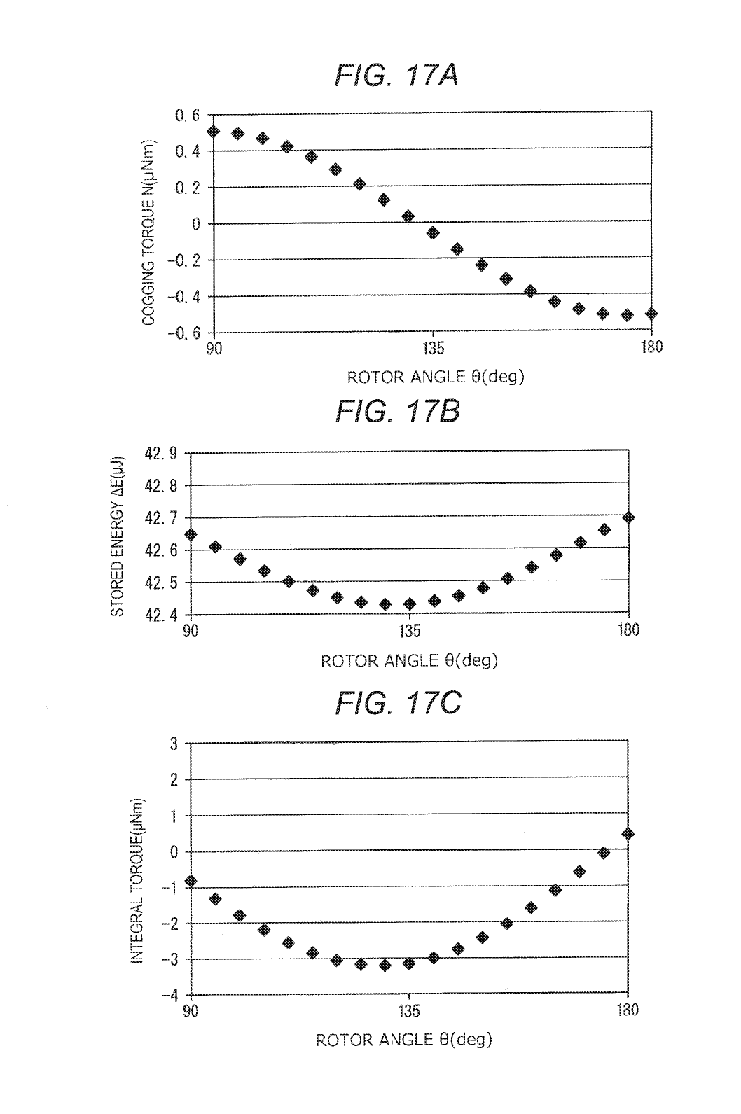

FIG. 17A is a diagram representing changes in cogging torque with rotor angle in the absence of deformation in the rotor housing 203. FIG. 17B is a diagram representing changes in stored energy with rotor angle in the absence of deformation in the rotor housing 203. FIG. 17C is a diagram representing changes in integral torque with rotor angle in the absence of deformation in the rotor housing 203.

In FIG. 17A, the horizontal axis represents rotor angle [deg], and the vertical axis represents cogging torque [μNm]. In FIG. 17B, the horizontal axis represents rotor angle [deg], and the vertical axis represents stored energy [μJ]. In FIG. 17C, the horizontal axis represents rotor angle [deg], and the vertical axis represents integral torque [μNm].

As can be seen from FIGS. 17A to 17C, in the absence of deformation in the rotor housing 203, the retained torque is about 0.514 [μNm], the stored energy ΔE is about 0.421 [μJ], the static angle is about 131.7 [deg], and the balance is 0.024. Here, “retained torque” is the mean value of maximum and minimum torque values. The stored energy ΔE is the difference between maximum and minimum values of stored energy. The static angle is an interpolated value at a low-potential position. The balance is a value obtained by dividing the maximum and minimum torque values by retained torque.

The low-potential position is where the prime angle is about 130 [deg], the work is about 31 [deg], and the interpolated value is 131.68. Here, “prime angle” is an angle where the integral torque takes a minimum value. The work is a value based on the minimum value of integral torque.

At the high-potential position, the prime angle is about 40 [deg], the work is about 13 [deg], and the interpolated value is 42.53.

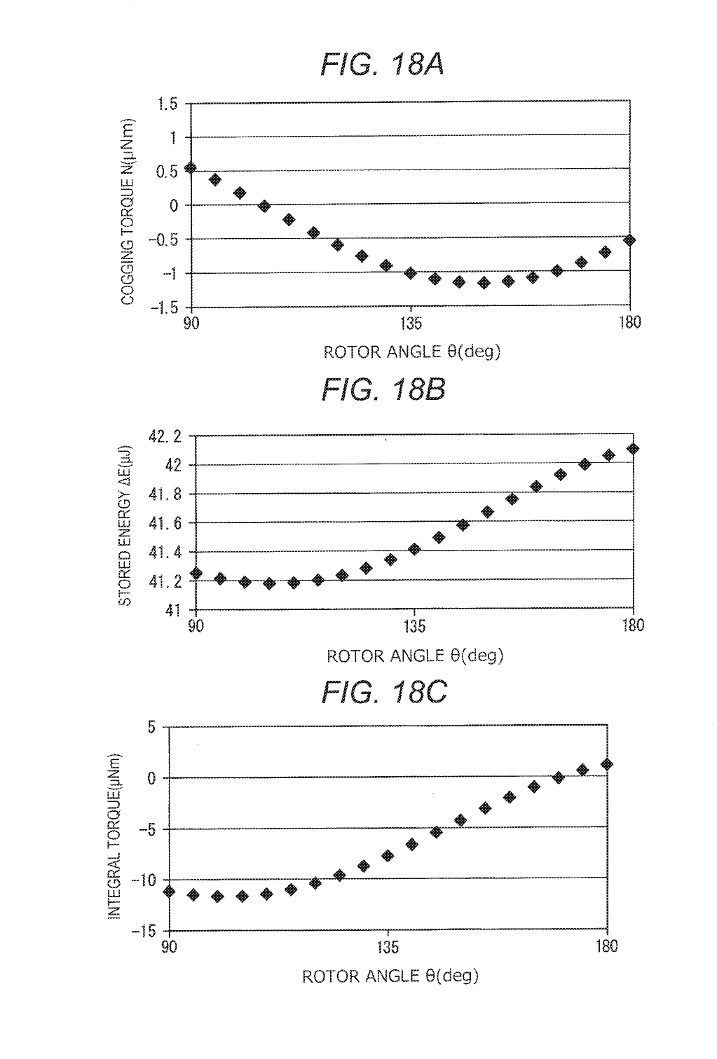

FIG. 18A is a diagram representing changes in cogging torque with rotor angle in the presence of deformation in the rotor housing 203a. FIG. 18B is a diagram representing changes in stored energy with rotor angle in the presence of deformation in the rotor housing 203a. FIG. 18C is a diagram representing changes in integral torque with rotor angle in the presence of deformation in the rotor housing 203a.

In FIG. 18A, the horizontal axis represents rotor angle [deg], and the vertical axis represents cogging torque [μNm]. In FIG. 18B, the horizontal axis represents rotor angle [deg], and the vertical axis represents stored energy [μJ]. In FIG. 18C, the horizontal axis represents rotor angle [deg], and the vertical axis represents integral torque [μNm].

As can be seen from FIGS. 18A to 18C, in the presence of deformation in the rotor housing 203a, the retained torque is about 1.147 [μNm], the stored energy ΔE is about 0.962 [μJ], the static angle is about 104.4 [deg], and the balance is 0.043.

The low-potential position is where the prime angle is about 100 [deg], the work is about 25 [deg], and the interpolated value is 104.43.

At the high-potential position, the prime angle is about 180 [deg], the work is about 41 [deg], and the interpolated value is 0.

As described with reference to FIG. 16, a shift occurs in rotor static angle, and the cogging torque increases in the presence of deformation in the rotor housing 203a, as opposed to when deformation is absent.

As described with reference to FIGS. 17A to 18C, a shift occurs in retained torque, stored energy ΔE, and static angle in the presence of deformation in the rotor housing 203a, as opposed to when deformation is absent. A shift occurs in the prime angle of the low-potential position, and in the prime angle of the high-potential position in the presence of deformation in the rotor housing 203a, as opposed to when deformation is absent.

As described above, in the presence of deformation in the rotor housing 203a, a shift occurs in stepping motor characteristics, and the stepping motor may fail to exhibit the desired performance.

In the present embodiment, the stator 201 is produced by punching after the formation of the molten portion, and the rotor housing 203 can have a form of a true circle, without deformation. The stator 201 produced in the present embodiment can thus be used to produce a stepping motor of the desired performance.

In the rotor housing 203 of the stator 201 produced with the method of the present embodiment, the arc excluding the groove 204 and 205 portions has a designed diameter of 1.8 mm with an error of minus 0 [μm] and plus 9 [μm]. Accordingly, the rotor housing 203 of the stator 201 produced with the method of the present embodiment has a roundness of about 99.5% (=1−(9×10⁻⁶/0.0018)).

### Variations of Embodiment

The following describes variations of the embodiment described above.

The foregoing embodiment described an example of the second production step in which, as described with reference to FIGS. 5 and 6, chromium is applied in substantially a straight line along the longer side (x-axis direction) of the hoop material. However, the invention is not limited to this embodiment.

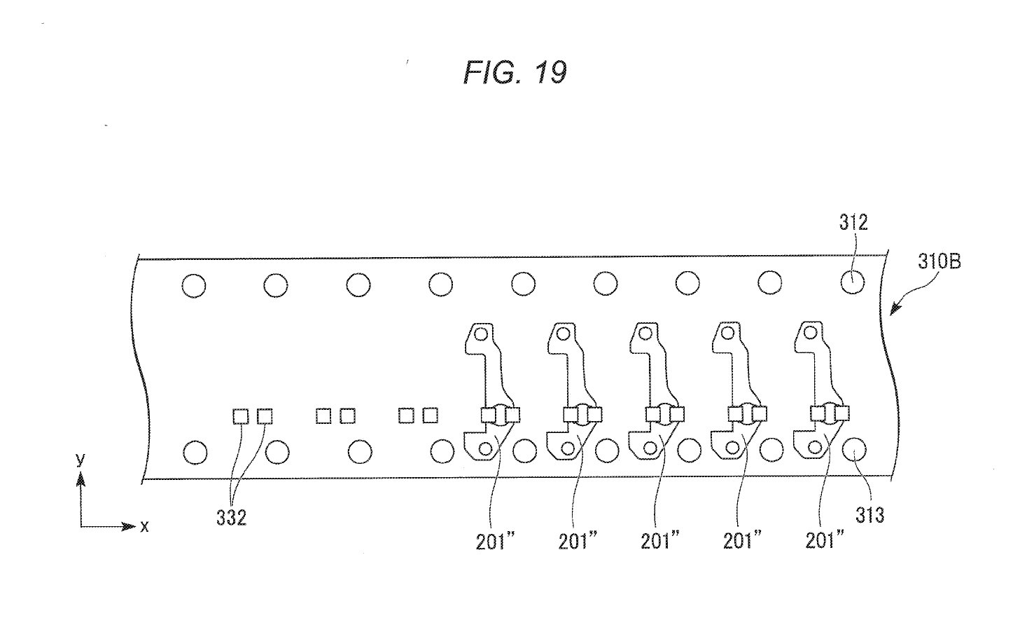

FIG. 19 is a diagram representing a variation of the embodiment with respect to chromium application. This variation differs from FIG. 6 in that chromium is applied to regions corresponding to the narrow portions 210 and 211 of the stator 201. In this variation, the paste applicator 322 in the second production step may apply a chromium paste to the hoop material 310B in regions 332 corresponding to the narrow portions 210 and 211, using the guide holes 312 and 313 as a reference.

With this variation, chromium can be applied in reduced amounts. With this variation, a laser beam can be applied to fewer positions, and the heat it generates in the hoop material can be reduced.

The foregoing embodiment described an example in which chromium is applied in substantially a straight line along the longer side (x-axis direction) of the hoop material. However, a chromium layer may be formed by plating chromium through a mask.

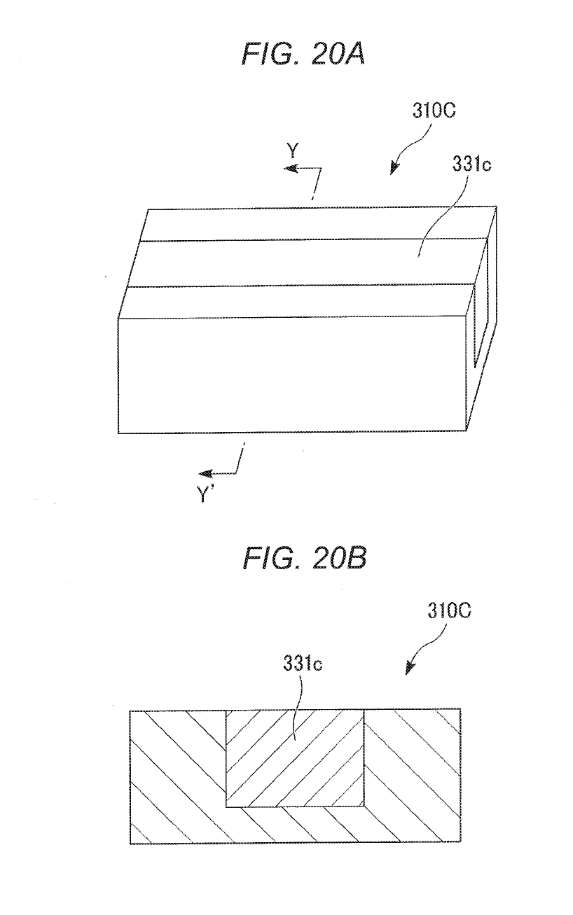

FIGS. 20A and 20B are diagrams showing a chromium layer formed in the hoop material according to this embodiment. FIG. 20A shows a perspective view of a hoop material 310C after the formation of a chromium layer according to a variation. FIG. 20B shows a cross sectional view after the formation of a chromium layer, taken at Y-Y′ of the hoop material 310C illustrated in FIG. 20A. In FIGS. 20A and 20B, the guide holes are omitted. The chromium layer formed by chromium plating is indicated by reference numeral 331c.

As with the case of the foregoing variation, for example, the chromium layer 331c may be formed in substantially a straight line in regions corresponding to the narrow portions 210 and 211 in the second production step, using the guide holes as a reference.

Alternatively, a chromium sheet material 331c may be embedded in regions corresponding to the narrow portions 210 and 211 of the hoop material 310C, using the guide holes 312 and 313 as a reference.

The foregoing embodiment has been described through the case where the stepping motor is a single-coil motor, and the stator is produced to accommodate a single-coil motor. However, the invention is not limited to this example, and the stepping motor may be a two-coil motor.

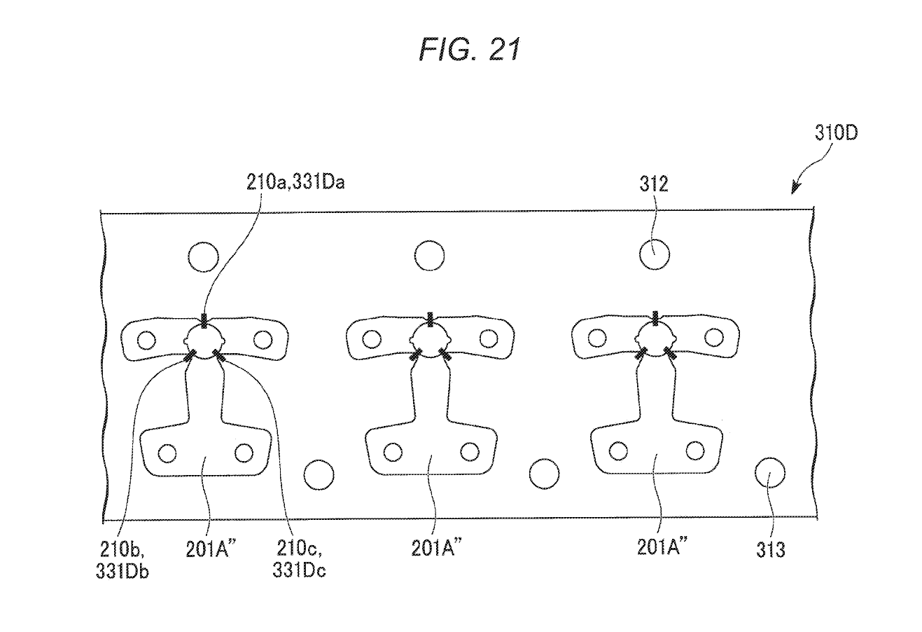

FIG. 21 is an elevational view of a hoop material 310D before punching stators 201A″ for two-coil motors according to a variation.

The narrow portions are indicated by reference numerals 210a, 210b, and 210c. Chromium is applied, and irradiated with a laser beam at positions 311Da, 331Db, and 331Dc.

As with the case of the foregoing embodiment, the production system 300 (see FIG. 5) in the second production step applies chromium to regions 311Da, 331Db, and 331Dc corresponding to the narrow portions 210a, 210b, and 210c, using guide holes 312 and 313 as a reference.

In the second production step, the production system 300 then applies a laser beam to the regions 311Da, 331Db, and 331Dc corresponding to the narrow portions 210a, 210b, and 210c, and forms the molten portion in these regions, using the guide holes 312 and 313 as a reference.

The production system 300 then punches the stators 201A in the third production step, using the guide holes as a reference, and performs a magnetic annealing process in the fourth production step to produce stators 201A for two-coil motors.

As with the case of the foregoing embodiment, the stator 201A is produced by punching the hoop material after the formation of the molten portion at the narrow portions 210a, 210b, and 210c, and the stator 201A can be stably produced in accurate shape, including the supersaturated region.

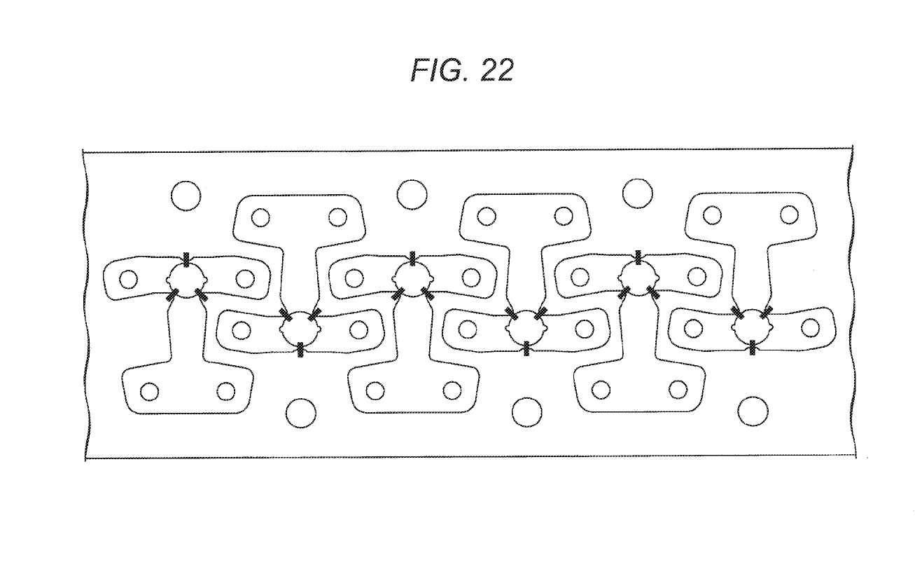

FIGS. 6, 19, and 21 described examples in which the stator is produced by punching the hoop material in one direction. However, the stator may be alternately punched as illustrated in FIG. 22. FIG. 22 shows an elevational view before pressing of stators for two-coil motors according to a variation. In this variation, the production system 300 in the second production step applies chromium to regions corresponding to stators 201B, and applies a laser beam to these regions, using guide holes 312 and 313 as a reference. Though the example of FIG. 22 is based on a stator for two-coil motors, a stator for single-coil motors also can be produced in an alternate fashion as in the example of FIG. 22. In this case, for example, the regions 332 corresponding to the narrow portions 210 and 211 in FIG. 19 may be applied also to the guide hole 312 side, in addition to the guide hole 313 side.

In the foregoing example, the stator is disposed in substantially a 90-degree angle with respect to the hoop material. However, the invention is not limited to this, and the stator angle with respect to the hoop material is not necessarily required to be 90 degrees. In this case, chromium may be applied to the region where the non-magnetic region is to be formed.

When the magnetic material is not a 38 permalloy containing 38 mass % nickel, the weight ratio of the chromium in the material is not 15%, unlike the foregoing embodiment. For example, when the magnetic material is a material, for example, Ni-2Cr, in which the weight ratio of the chromium representing the non-magnetic region in a ternary alloy diagram (FIG. 11) is not 15%, the chromium concentration needs to be higher than the weight ratio of the chromium in such a material.

### Description of Other Third Production Steps

The embodiment represented in FIG. 5 described an example of the third production step in which the pressing machine 342 (FIG. 5; a finishing machine) is used for punching. However, the third production step is not limited to this.

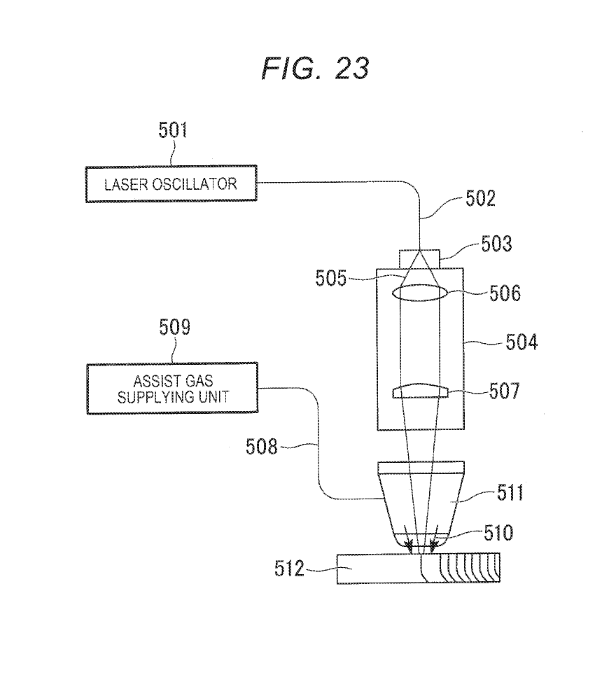

FIG. 23 is a diagram representing an example in which the third production step in the stator producing method according to the embodiment is performed by laser cutting.

In this example, a laser cutter (a finishing machine) of, for example, the configuration shown in FIG. 23 is used for working, instead of the pressing machine 342 of FIG. 5.

As illustrated in FIG. 23, the laser cutter includes a laser oscillator (a solid-state laser oscillator such as a YAG laser and a disc laser, or a fiber laser oscillator) 501; an optical fiber 502 connected at one end to the laser oscillator 501; and a laser head 504 connected to the laser oscillator 501 via a laser emitting section 503 connected to the other end of the optical fiber 502. The laser head 504 includes a collimating lens 506 that produces parallel rays from a laser beam 505 emitted from the laser emitting section 503, and a condensing lens 507 that condenses parallel rays of the laser beam 505. An assist gas supplying unit (the assist gas is at least 90 volume % of N₂ gas, or at least 90 volume % of an inert gas such as argon and helium) 509 is connected to a cutting nozzle 511 via an assist gas pipe 508. The laser beam 505 condensed through the condensing lens 507 is emitted downwardly below the cutting nozzle 511, together with an assist gas 510. For laser cutting, a material to be cut (a magnetic sheet material) 512 is disposed, for example, 2 to 3 mm below the bottom face of the cutting nozzle 511.

The material to be cut (a magnetic sheet material) 512 is a part of a roll of a hoop material after the second production step of FIG. 5.

The configuration of the laser cutter shown in FIG. 23 is merely an example, and the laser cutter is not limited to this configuration.

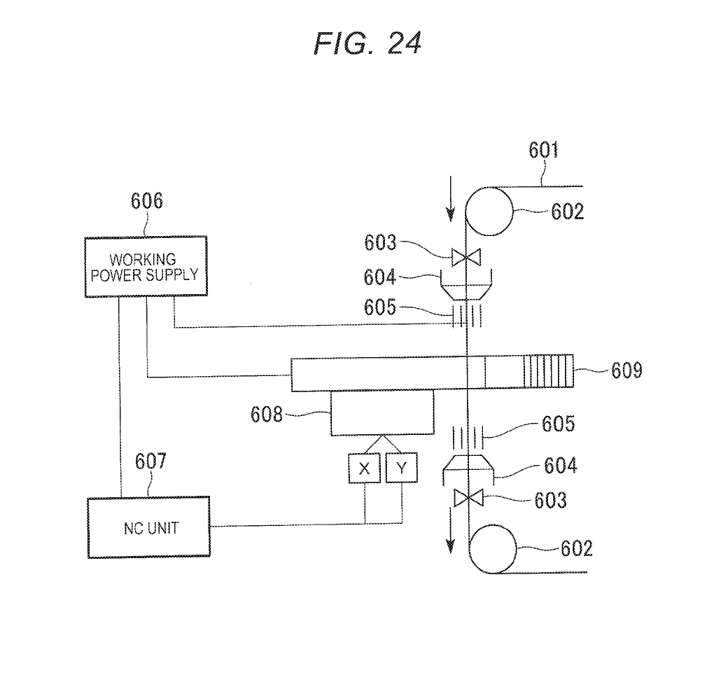

FIG. 24 is a diagram representing an example in which the third production step in the stator producing method of the embodiment is performed by wire discharge.

In this example, a wire discharge machine (a finishing machine) of, for example, the configuration shown in FIG. 24 is used for working, instead of the pressing machine 342 of FIG. 5.

In wire discharge, as illustrated in FIG. 24, a wire electrode 601 moves along upper and lower guide rollers 602 and wire guides 603, and is taken up in the direction of arrow. The wire electrode 601 is subjected to the required tension and traveling speed by a brake and a take-up unit (neither is illustrated), and a material to be cut (a magnetic sheet material) 609 is worked against the wire electrode 601 moving in a straight line between the wire guides 603. Indicated by reference numeral 608 is an X-Y table capable of moving the material to be cut (a magnetic sheet material) 609 in X and Y directions by carrying it. Indicated by reference numeral 604 are working liquid nozzles that supply a working liquid. The working liquid nozzles 604 are provided above and below the material to be cut (a magnetic sheet material) 609, concentric to the wire electrode 601 and surrounding the wire guides 603. A working power supply 606 is connected to the wire electrode 601 with a conducting member (not illustrated), and applies a pulse discharge between the wire electrode 601 and the material to be cut (a magnetic sheet material) 609 to cut the material to be cut (a magnetic sheet material) 609 by discharge. An NC unit 607 is provided to control various working processes in the wire discharge.

The material to be cut (a magnetic sheet material) 609 is a part of a roll of a hoop material after the second production step of FIG. 5.

The configuration of the wire discharge machine shown in FIG. 24 is merely an example, and the wire discharge machine is not limited to this configuration.

The third production step is not limited to punching (FIG. 5), laser cutting (FIG. 23), and wire discharge (FIG. 24), and may use other cutting methods or working methods, or non-contact cutting methods.

While the present invention has been described with reference to certain embodiments, the present invention is in no way limited by these embodiments, and various changes and replacements may be made thereto without departing from the gist of the invention.

What is claimed is:

1. A method for producing a stator for motors, the method comprising:
an unmagnetizing step of forming a non-magnetic region in a magnetic sheet material; and
a working step of working a part of the non-magnetic region in the magnetic sheet material so as to form a hole for a rotor of a motor.

2. The method according to claim 1, wherein the unmagnetizing step includes:
a chromium applying step of applying chromium to the magnetic sheet material; and
a laser irradiation step of applying a laser beam to the magnetic sheet material in thickness direction.

3. The method according to claim 1, wherein the unmagnetizing step includes:
a chromium applying step of continuously applying chromium to the magnetic sheet material; and
a laser irradiation step of applying a laser beam to the magnetic sheet material in thickness direction.

4. The method according to claim 2, which includes a guide-hole forming step of forming a guide hole through the magnetic sheet material before the unmagnetizing step, wherein:
the chromium applying step uses the guide hole as a reference to apply chromium,
the laser irradiation step uses the guide hole as a reference to apply a laser beam, and
the working step uses the guide hole as a reference to work a part of the non-magnetic region.

5. The method according to claim 1, wherein:
the magnetic sheet material is a sheet material of an Fe—Ni—Cr alloy containing 37.5% to 38.5% nickel, 7.5 to 8.5% chromium, and 52.5% to 54.5% iron, and wherein
the non-magnetic region includes a region with a chromium content of 15% or more.

6. The method according to claim 1, wherein the working step is a step of punching a part of the non-magnetic region, a step of cutting a part of the non-magnetic region with a laser, or a step of working a part of the non-magnetic region by wire discharge.

7. A stator for motors, comprising a non-magnetic molten region formed at a circumference of a rotor hole of a magnetic sheet material by melting and unmagnetizing the magnetic sheet material, the non-magnetic molten region having a cross section that becomes smaller from a first surface of the magnetic sheet material toward a second surface of the magnetic sheet material in thickness direction.

8. The stator for motors according to claim 7, wherein the rotor hole has a roundness of 99.5% or more.

9. The stator for motors according to claim 7, wherein:
the magnetic sheet material is a sheet material of an Fe—Ni—Cr alloy containing 37.5% to 38.5% nickel, 7.5 to 8.5% chromium, and 52.5% to 54.5% iron, and wherein
the non-magnetic molten region includes a region with a chromium content of 15% or more.

10. The stator for motors according to claim 7, wherein the chromium in the non-magnetic molten region is 6% to 18% higher by weight than in a region of the magnetic sheet material other than the non-magnetic molten region.

11. The stator for motors according to claim 7, wherein the non-magnetic molten region is a region of the magnetic sheet material where the distance from the rotor hole to an outer edge of the magnetic sheet material is narrower than in other parts of the magnetic sheet material.
